(19) United States
(12) Patent Application Publication
(10) Pub. No.: US 2005/0131737 A1
(43) Pub. Date: Jun. 16, 2005

(54) Method and system for automating occupational health and safety information management

(75) Inventors: Brad Joseph, Toledo, OH (US); Denise Clement, Dearborn, MI (US); Gordon Reeve, Canton, MI (US); Greg Stone, Beverty Hills, MI (US); Walter Talamonti, Dearborn, MI (US); William Heckman, Grosse Ile, MI (US); Beverly Kirk Shull, Farmington Hills, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/737,409

(22) Filed: Dec. 16, 2003

(51) Int. Cl. G06F 17/60

(52) U.S. Cl. 705/2

(57) ABSTRACT

An electronic medical record module receives data concerning patient medical visits resulting from occupational health or safety incidents processes the data based on pre-defined OSHA logic to automatically identify one or more patient medical visits that are OSHA-recordable, and outputs a plurality of different reports including patient medical visits that are OSHA-recordable. An incident investigation module electronically dispatches an investigator to investigate occupational health or safety incidents, and receives data concerning the investigations including corrective actions to avoid reoccurrence. A data analysis module filters received data at one or more filter levels (e.g. worker characteristics, injury/illness codes, work assignment, time period, etc.) and generates a plurality of reports based on the filtered data.

### BACKGROUND OF THE INVENTION

1. Field of the Invention

This invention relates generally to occupational health and safety, and more specifically to a method and system for automating occupational health and safety information management.

2. Background Art

The Occupational Health and Safety Administration (“OSHA” www.osha.gov) was established in 1971 to ensure safe and healthful workplaces in America. OSHA sets forth and maintains a comprehensive set of standards for assuring safe and healthful conditions for working men and women. Since the agency was created in 1971, workplace fatalities have been cut in half and occupational injury and illness rates have declined 40 percent. At the same time, U.S. employment has doubled from 56 million workers at 3.5 million worksites to 111 million workers at 7 million sites today.

Maintaining compliance with OSHA standards and managing health and safety-related information is an important and challenging task—especially for larger organizations employing hundreds or thousands of employees nationally. First, there is a tremendous amount of information to gather, process, analyze and report to establish compliance (e.g. patient medical visits, organizational injury/illness statistics, OSHA-required reports, etc.). Second, information originates from many different sources throughout an organization. This fact challenges centralized management of occupational health and safety-related information.

The following table compares disadvantages of the conventional methodology for managing occupational health and safety-related information against certain advantageous aspects of the present invention.

| Conventional Methodology | Aspects of Present Invention |
|---|---|
| No standardized data | Easy web-based single |
| Data analysis for decision | point of entry for |
| making is difficult | information shared across |
| Potential for lost | the entire business |
| paperwork | Ability to analyze data |
| Variety of reporting | for process improvement |
| methods | Improved ease-of-use and |
| Pen and paper reporting | functionality |
| Time-consuming | No loss of existing |
| Requires supervisor's | functionality |
| direct involvement | Standardizes incident |
| | investigation and reporting |
| | Electronic reports are |
| | immediately available to: |
| | Plant Managers |
| | Safety Engineers |
| | Supervisors |
| | UAW Health & Safety Reps. |

What is needed is a comprehensive system and methodology for the efficient administration of occupational health and safety information and OSHA compliance. Embodiments of the present invention provide such a solution—leading to a reduction in injury, illness and loss through prevention.

### SUMMARY OF THE INVENTION

One embodiment of the present invention is a computer-implemented occupational health and safety information management (“OHSIM”) system.

Embodiments of the present invention enable users to manage occupational health and safety information. Users can input medical data, incident investigation data, perform data analysis, and generally administer the management of occupational health and safety information in an automated fashion. Functionality associated with the present invention may be divided into three general modules: an Electronic Medical Record (“EMR”) module, an Incident Investigation module (“IIM”), and a Data Analysis module (“DAM”).

Within a corporate environment, several different users will find aspects of the present invention beneficial. For example, plant operations staff, safety engineers and union representatives may use aspects of the present invention to access statistical information and to analyze/control risk situations promoting safety in the workplace. A company's clinical healthcare providers may use aspects of the present invention to easily open/edit occupational and personal medical visits, update medical history information, open/edit medical leaves, and trigger investigations of work related injury/illness events. Supervisors, team leaders and safety engineers may use aspects of the present invention to enter, maintain and process/query incident investigation data, including information on property damage and near miss events. Plant level application administrators may use aspects of the present invention to adjust security access levels, as well as administer data reporting tools. Worker's compensation representatives may use aspects of the present invention to access occupational visit data and personal visit information. Human resources representatives may use aspects of the present invention to open/edit or create medical leaves and administer job placement/no work available (NWA) leaves. Corporate and plant operations staff, superintendents, area managers, plant level reporting personnel, and medical staff may use aspects of the present invention to query statistical information about a particular plant or multiple plants.

Benefits of the present invention include data-driven company processes which reduce workplace hazards, standardized processes, efficient in-plant medical data management, a standardized single point of entry for data collection, and electronic reports that are available to plant managers, safety engineers, supervisors, union representatives, and many others.

Embodiments of the present invention include methodologies, computer systems and computer software for automated health and safety information management. Depending upon the particular embodiment, aspects of the present invention may include an electronic medical record module configured to receive a plurality of data concerning patient medical visits resulting from occupational health or safety incidents (e.g. injuries, illnesses, etc.), process the data based on pre-defined OSHA logic to automatically identify one or more patient medical visits that are OSHA-recordable, and output one or more reports including a summary of the data characterizing one or more patient medical visits that are OSHA-recordable.

Another aspect of the present invention includes an incident investigation module configured to electronically dispatch an investigator to investigate one or more of the occupational health or safety incidents, and receive a plurality of data concerning an investigation of one or more of the occupational health or safety incidents including one or more corrective actions to avoid reoccurrence of the one or more of occupational health or safety incidents.

Another aspect of the present invention includes a data analysis module configured to filter received data at one or more filter levels (e.g. worker characteristics, injury/illness codes, work assignment, time period, etc.) based on one or more user-defined criteria, and generate a plurality of reports based on the filtered data.

Data characterizing the patient medical visit may include data representing the date of the incident, whether the patient died or lost consciousness, diagnosis, treatment, medications, test orders, referrals, medical leaves, medical restrictions, an indication as to whether the patient is fit for work, etc.

According to another aspect of the present invention, an indication may be automatically displayed as to whether enough data characterizing the patient medical visits has been provided to determine whether the visit is OSHA-recordable.

According to another aspect of the present invention, functionality is provided enabling users to query collected data in a variety of different manners to produce or otherwise output a plurality of different report types. For example, a report summarizing the occupational health or safety incidents for a particular organizational location or patient, a report summarizing patient medical leaves of absence for a particular organizational location or patient, a report summarizing patient medical restrictions for a particular organizational location or patient, a report summarizing patient medical visits for a particular organizational location or patient, a report summarizing one or more incident investigations, a report summarizing corrective actions to avoid reoccurrence of the one or more of occupational health or safety incidents, etc.

### BRIEF DESCRIPTION OF THE DRAWINGS

FIG. 1 illustrates an overview of the OHSIM system in accordance with a preferred embodiment of the present invention;

FIG. 2 is a block-flow diagram illustrating a methodology or flow-of-events associated with the EMR module according to one embodiment of the present invention;

FIG. 3 is a block-flow diagram illustrating a preferred methodology or flow-of-events for recording an occupational medical visit using one embodiment of the present invention;

FIG. 4 is an example graphical user interface including a complete/verification status screen in accordance with one aspect of the present invention;

FIG. 5 is an example GUI for defining a diagnosis in accordance with one aspect of the present invention;

FIG. 6 is an example GUI for implementing an OSHA log analysis in accordance with one aspect of the present invention;

FIG. 7 is a block-flow diagram illustrating a preferred methodology for using and implementing the IIM;

FIG. 8 is an example GUI illustrating a Work Queue Search in accordance with one aspect of the present invention;

FIG. 9 is a multi-tab GUI for collecting a plurality of information relating to a new incident investigation in accordance with one aspect of the present invention;

FIG. 10 illustrates an example view and investigation screen in accordance with one aspect of the present invention;

FIG. 11 graphically illustrates a preferred methodology for utilizing the data analysis aspect of the present invention;

FIG. 12 is an example GUI having a plurality of tabs associated with data selection and output in the DAM;

FIG. 13 is an example DAM form 88 for specifying the format of the data to be output;

FIG. 14 is an example chart output in connection with the DAM aspect of the present invention;

FIG. 15 is an example DAM GUI for specifying detail selections associated with statistical reporting in the DAM aspect of the present invention; and

FIG. 16 is an example detail selection screen for organizational variables in accordance with the DAM aspect of the present invention.

### DETAILED DESCRIPTION OF THE PREFERRED EMBODIMENT(S)

One embodiment of the present invention is a computer-implemented occupational health and safety information management system (“OHSIM”). Aspects of the present invention may be divided into three general modules: the Electronic Medical Record (“EMR”) module, the Incident Investigation module (“IIM”), and the Data Analysis module (“DAM”). As will be discussed in greater detail below, each of the modules may be implemented in computer software and hardware and may be configured to share information in an electronic fashion with one another.

Roles and tasks of system users can vary widely depending on the particular implementation of the present invention. In accordance with a preferred embodiment of the present invention, however, Table 1 below illustrates a preferred matrix of user roles and responsibilities.

TABLE 1

| Tasks and | Medical | Super- | Safety | Super- | Area | HR/ |
|---|---|---|---|---|---|---|
| User Roles | Personnel | visors | Engrs | intendents | Mgrs | HRA |
| Work Queue | X | X | X | X | X | X |
| Enter Injury/ | X | | | | | X |
| Illness | | | | | | |
| Information | | | | | | |
| Initiate | | X | X | | | |
| Investigation | | | | | | |
| Edit | | X | X | | | |
| Investigation | | | | | | |
| View | | X | X | X | X | |
| Investigation | | | | | | |
| Complete | | X | X | | | |
| Investigation | | | | | | |
| Review Near | | X | | | | |
| Miss Reports | | | | | | |
| Review | | | X | X | | |
| Investigation | | | | | | |
| Accept/Reject | | | X | X | | |
| Investigation | | | | | | |
| Safety Sign- | | | X | | | |
| Off | | | | | | |
| Generate | X | X | X | X | X | X |
| Reports | | | | | | |
| Restrictions/ | X | X | X | | | X |
| Job | | | | | | |
| Placements | | | | | | |

Those of ordinary skill in the art of computer programming will recognize that OHSIM functionality including functionality supported by the EMR, IIM and DAM modules may be implemented in a wide variety of different graphical user interface (GUI) configurations across a plurality of different computing platforms in a variety of different programming languages. As such, the present disclosure will describe user interfaces in terms of example functionality that those aspects of the present invention may be configured to support. Of course, the scope of the present invention is not limited to the particular examples or embodiments provided herein.

Preferably, functional aspects of the present invention are implemented in a Web-based fashion such that user interfaces are viewable and operational via Web browser (e.g. Internet Explorer, Netscape Navigator, etc.) in operable communication with one or more servers and associated databases.

Table 2 correlates several categories of OHSIM users with the OHSIM module these users may utilize. Notably Table 2 is an example—an unlimited number of different users may use any and all OHSIM modules in connection with occupational health and safety activities.

TABLE 2

| User Role | EMR | IIM | DAM |
|---|---|---|---|
| Safety Engineers | | X | X |
| Supervisors & | | X | X |
| Superintendents | | | |
| Medical Staff | X | | X |
| Human Resources | X | | |
| Worker's Compensation | X | | |

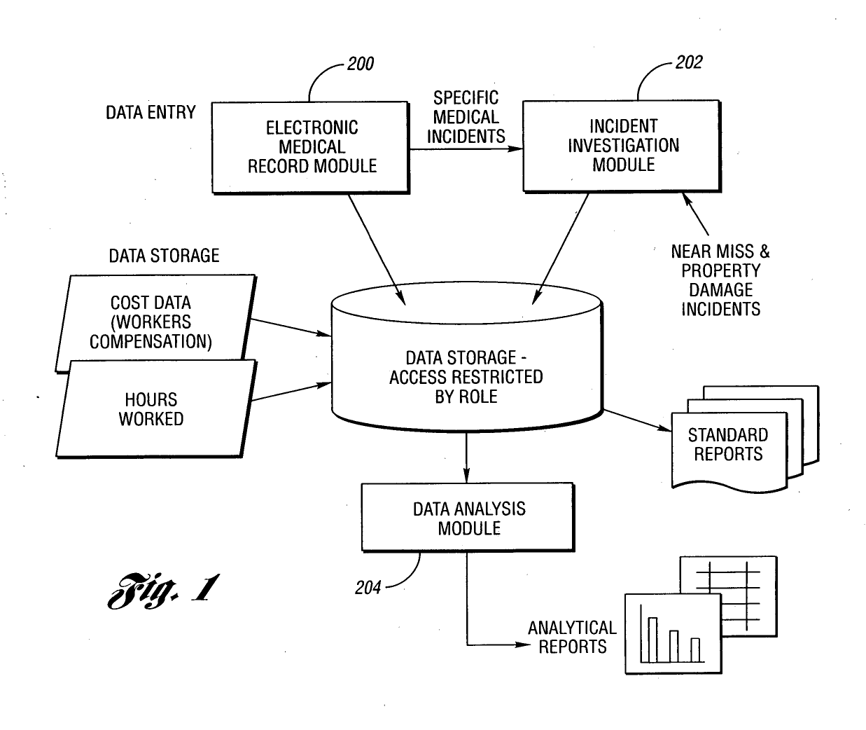

FIG. 1 illustrates an overview of the OHSIM system in accordance with a preferred embodiment of the present invention. Notably, the content and arrangement of FIG. 1 may be modified to best fit a particular implementation of the present invention. Aspects of FIG. 1 are described in greater detail below.

Electronic Medical Record Module (200)

The EMR module 200 provides users access to online medical record functionality with which personal and occupational medical visits can be documented, viewed and updated on a personal or corporate plant/facility level. This aspect of the present invention enables a user to view and update a person's medical history, document medical visits, open and update medical leaves of absence, generate reports for a person as well as a corporate plant/facility reports, update a person's demographic information, view a person's history of restrictions, and update medical user information. These and other features of the EMR module are described in greater detail below.

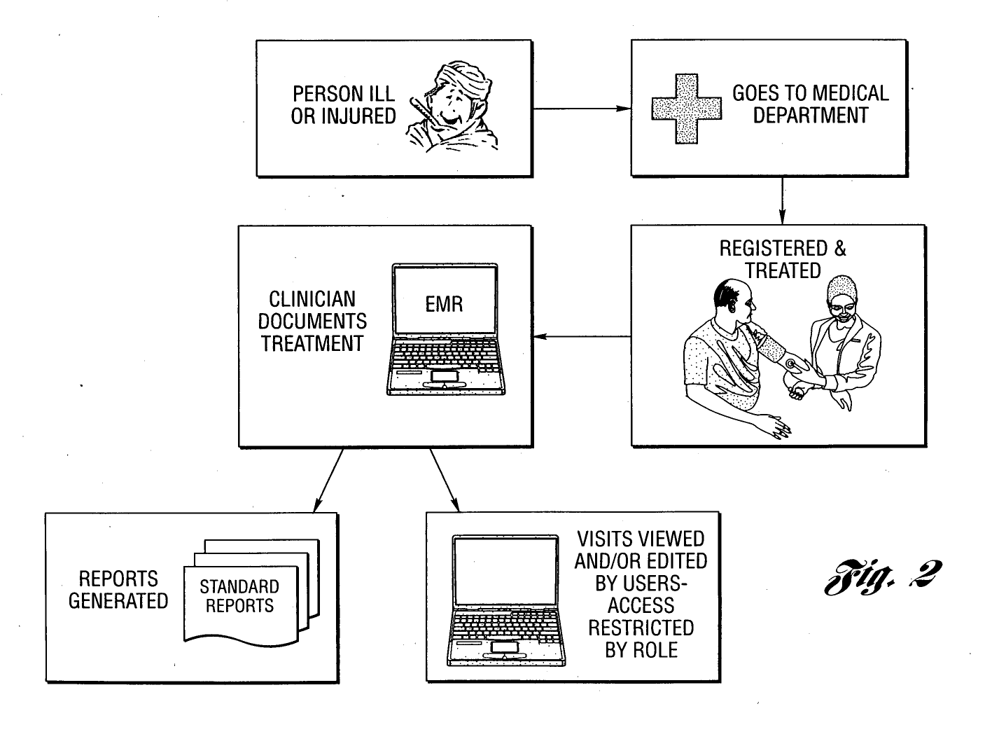

FIG. 2 is a block-flow diagram illustrating a methodology or flow-of-events associated with the EMR module according to one embodiment of the present invention.

One aspect of the EMR module supports or otherwise enables the creation of an OSHA report having a log of OSHA-recordable events that are designated as such automatically based on the application of OSHA logic to data associated with or otherwise characterizing the events. These features of the present invention are described in greater detail below.

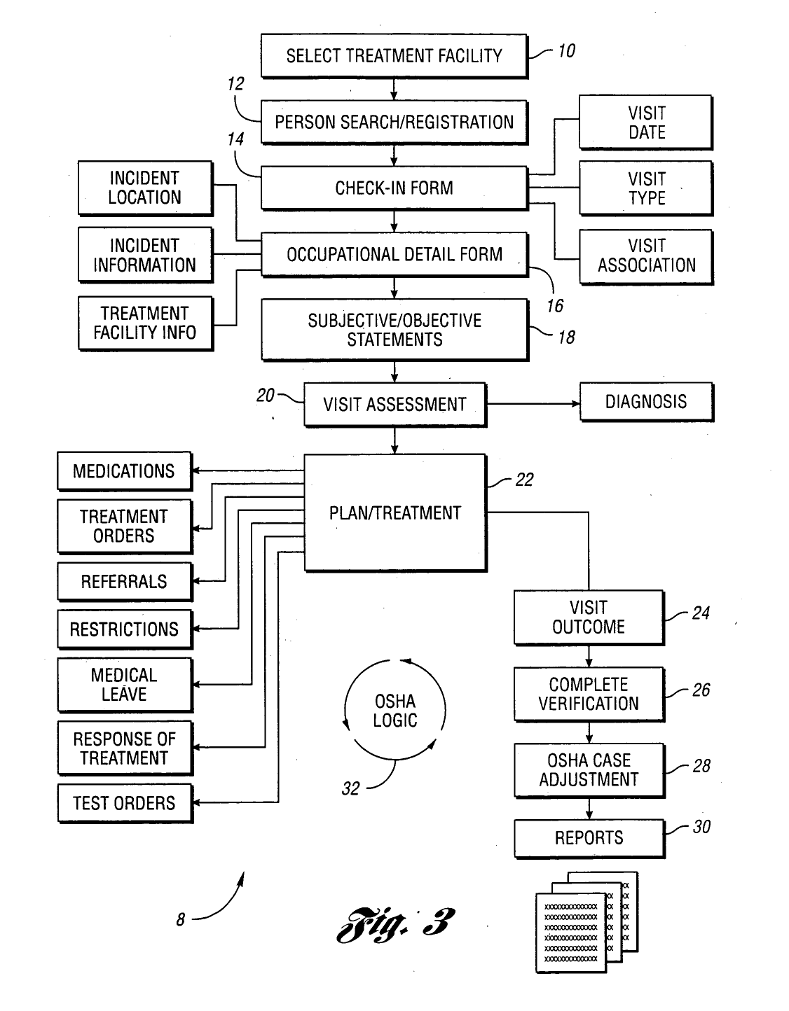

FIG. 3 is a block-flow diagram illustrating a preferred methodology or flow-of-events for recording an occupational medical visit using one embodiment of the present invention. Depending on the nature and history of the medical visit, the visit may be OSHA recordable, a decision that is automatically made as discussed in greater detail below.

A computer-implemented embodiment of the present invention receives user-specified data characterizing an occupational medical visit. First, a user may select or otherwise specify an occupational treatment facility as represented in block 10. Next, the user may query a database of employees for the particular injured or ill patient, as represented in block 12. If no such patient is located, the application provides a new patient registration form.

Next, a check-in form may be completed for the injured/ill person, as presented in block 14. Check-in information submitted to the form may include the name of the injured/ill person, the person's date of birth, the treatment facility, the visit date and time, the visit type (e.g. short, personal, occupational, etc.), and a visit association (e.g. whether the visit is a follow-up to an existing condition or an initial visit).

As represented in block 16, an occupational detail form is provided for receiving a plurality of information relating to the incident. Information may include, but is not limited to the location of the incident (e.g. on/off premise, plant/building, department, work location, day, etc.), a date for the incident or onset of illness, a description of what the injured/ill person was doing before the incident/illness occurred, the injured/ill person's personal statement of the incident, a health care representative's interpretation of the statement or injury/illness, the object or substance that directly harmed the person, the tool/equipment used during the incident, the type of the injury/illness, and treatment facility information (e.g. physician name, emergency room, overnight, out-patient, etc.), an indication as to whether recessitation was required, an indication as to whether the person lost consciousness, and an indication as to whether the person died. Notably, certain fields within the occupational detail form are utilized by OSHA logic (discussed in greater detail below) to determine certain items for OSHA-recordable visits (e.g. OSHA log ID, which OSHA rules to follow, the creation of an OSHA case, etc.).

As represented in block 18, one or more interfaces may be provided for receiving a subjective and objective description of the injury/illness as well as an indication as to the patient's current medication and any objective measurements. According to one embodiment of the present invention, the subjective/objective statements do not affect OSHA recordability.

As represented in block 20, a variety of forms may be provided for receiving input assessing the person's injury/illness and adding a diagnosis for same. According to one embodiment, the assessment if via free text data entry. A form for adding a diagnosis may be provided including items including, but not limited to, an indication as to whether the diagnosis is a primary diagnosis or not, an indication of the body part affected, an indication as to the laterality of the body part, an indication as to whether the diagnosis is a simplified diagnosis (e.g. diagnosis selected from a drop-down menu), a flag for whether an illness is involved, an ICD-10 diagnosis parameters (e.g. chapter, main, subcategory 1, subcategory 2, clarification, etc.).

As represented in block 22, one or more user interfaces may be provided enabling users to define a plan or treatment for the injured/ill person. The treatment/plan may include a free-text description of the plan or procedure, treatment orders, medications, referrals, restrictions, medical leave, response to treatment, test orders, etc. Adding a medication to the plan/treatment may include specifying the name of the medication, the dosage, the number to dispense, special instructions (e.g. DAW, with food, drowsiness (precautions), etc.), an indication as to whether the medication was dispensed in medical, an indication as to whether a refill for the medication is available, and if so, refill limits, and a medication alert.

Adding restrictions to the plan/treatment may include the type of restriction (e.g. permanent, temporary, etc.), a main category for the restriction, a begin date, a through date, and a revisit date. Adding a medical leave to the plan/treatment may include specifying the type of leave (e.g. personal, occupational, etc.), the reason for the leave, the leave status, the begin date, the updated date, an indication as to who requested the leave, an indication as to how the leave was requested, a description of the reason or comments regarding the leave, DROP, the last day worked, contact information for the medical leave, and a description of the diagnosis.

Adding test orders to the plan/treatment may include specifying the type of test, the laterality, the order date, the order time, an indication as to whether the test was performed in-house or external, an indication as to whether a fracture occurred, and a description of the results or interpretation of the test orders.

As represented in block 24, a visit outcome form may be provided in which a user specifies whether or not the injured/ill person is fit for work. This aspect of the present invention may affect the OSHA-recordability of the visit. Visit outcome information may include an indication as to whether the injured/ill person is fit for work, an indication as to whether a revisit is required, an indication as to the date and time out, an indication as to whether a worker's compensation department should review the event, a worker's compensation code (if applicable), and an indication as to whether this event raises a privacy concern for the injured/ill person.

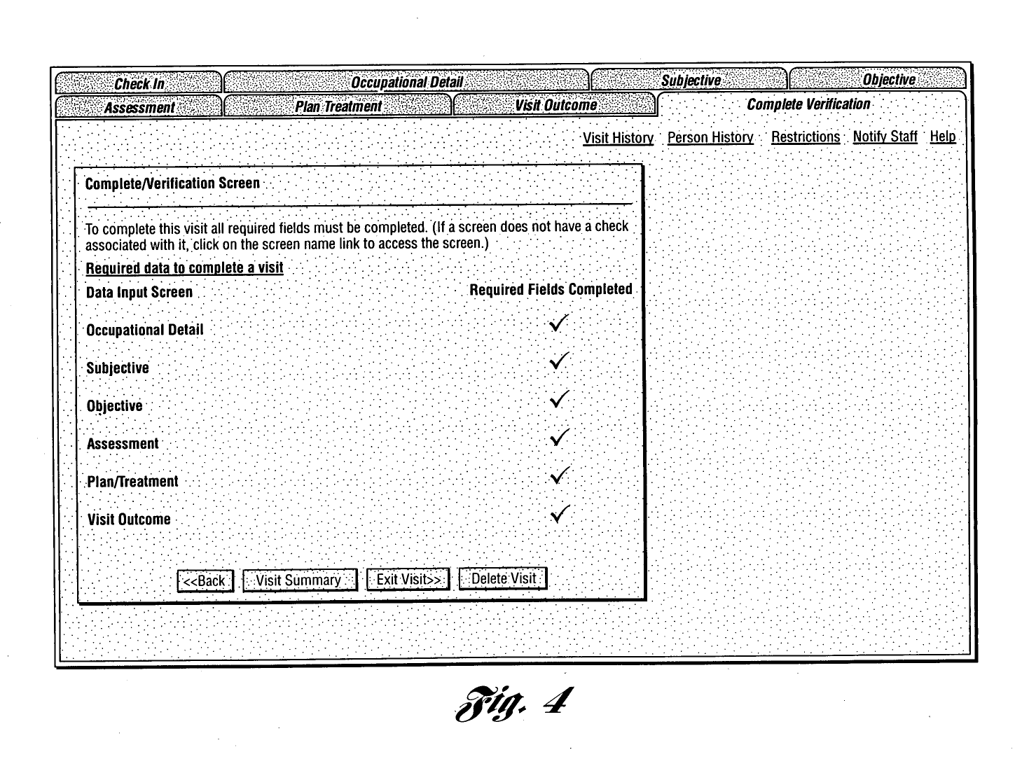

As represented in block 26, a complete verification form may be provided as feedback to the user indicating whether or not certain required data input fields had been properly completed. FIG. 4 illustrates an example graphical user interface for this aspect of the present invention. According to one embodiment of the present invention, the complete/verification step 26 triggers the OSHA logic. As discussed in greater detail below, the OSHA logic 32 is implemented to automatically determine based on the input data whether or not the event is OSHA-recordable.

As represented in block 28, an OSHA case adjustment form may be provided enabling a user to increase or decrease days away or restricted days for an OSHA case. This screen may also display medical leaves and/or medical restrictions associated with the visit(s).

As represented in block 30, a plurality of reports (e.g. regulatory reports, U.S. OSHA, etc.) may be generated. Reports may include an OSHA log of OSHA-recordable events, an OSHA injury/illness incident report, an OSHA summary report, and an OSHA execution and privacy concern summary. Preferably, a plurality of user-definable or user-selectable criteria are provided for querying a database of received data associated with OSHA visits for populating reports generated by the present invention. For example, an OSHA log analysis report may include query parameters such as plant/building, calendar year, incident date, incident date range, case number, case number range, incident department, incident work location, case type (e.g. illnesses only, injuries only, etc.), person name, person ID number, and OSHA cases (e.g. active, closed, etc.). Additionally, reports by facility or individual with regards to visits, medical leaves and/or medical restrictions may be provided. As discussed in greater detail below, a work queue may also be provided to assist medical workers with completing patient visits.

A “Create Visit” GUI (not shown) enables a user to create a new or “original” patient visit, or to open a “revisit” (e.g., to open an existing visit for editing or entering additional information such as test results). Preferably, a search feature is provided enabling a user to search among patients (e.g., employees at a particular plant/facility, by treatment facility or corporate-wide including by country). Patients may be searched according to demographic information including name, ID no., treatment facility, plant, etc.).

If a patient is not found during a search, a registration screen is preferably provided enabling the user to register the patient within the system. Patient registration may include defining conventional demographic information as well as the patient's plant/facility, medical treatment facility, and employer (e.g., in the event that the patient/employee is a contract employee).

A “Check-In” GUI (not shown) enables a user to define a medical visit. Visit types may be defined by selecting from a “short”, “personal” or “occupational” visit identifier. Next, the user defines visit data and time-in. In accordance with a preferred embodiment, once the check-in date and time have been saved by the user, they cannot be changed. According to one embodiment, if the user selected a “personal” or “occupational” visit, the user next selects a “visit association”, if applicable. If the current visit is a new or “original” visit, then there is no association. However, if the current visit is a follow-up, then the user associates the current visit with the original visit that it derives from. Preferably, the user is provided with a GUI to view information regarding any other visits that have been associated with an original visit.

A “Short Visit” GUI (not shown) enables a user to quickly define an office visit. Short visits are typically used for minor problems that do not require extensive treatment or testing. Once the short visit option has been selected additional fields appear on the screen. The visit may be changed to personal or occupational at any time before the record is saved.

Information collected during a short visit may include a primary/secondary diagnosis, a primary/secondary treatment/order, a data/time out, and additional comments, if necessary. Preferably, a primary diagnosis is selected from a diagnosis list available for short visits. A patient's vital signs may also be input during a short visit.

Preferably, a user is provided with links to view various categories of information associated with the current patient. For example, links may be provided for a patient's complete visit history, or only visits deriving from the current original visit. Additional links may provide a user with a person's medical, medication and allergy history, current and historical patient restrictions, and staff notifications/messages, etc.

For First Time Occupational Visits (FTOVs), a GUI may be provided (not shown) in which the user inputs the details of an occupational incident. FTOV information to be input may include the location of the incident (plant, building, department, bay, etc.), the date/time of the incident, a description of what the patient was doing just prior to the incident, the patient's account of the incident, a user's (e.g., health care representative's) interpretation of the patient's account, the objects/substances that caused the incident, the tool/equipment being used at the time, the injury/illness type, indications as the whether resuscitation was required, whether the patient lost consciousness, and whether the patient died. Preferably, treatment facility information includes the name of the associated physician or health care professional, the location where the person was treated, etc.

For personal and occupational visits, the user may also input subjective statements, such as a person's description of the reason for a visit, information on history or healthcare problems into a “Subjective” EMR GUI. Preferably, data entered in the person's personal account (described above) is automatically copies to the Subjective GUI in a first time occupational visit. It is additionally preferred that once this data is saved, it cannot be edited. Current medications documented in the person's record may also be displayed.

An “Objective” GUI (not shown) may be provided for recording clinical observation information (i.e., factual and measurable data—vital signs, body mass index, physical condition, etc.) regarding the person's medical condition at the time of the visit.

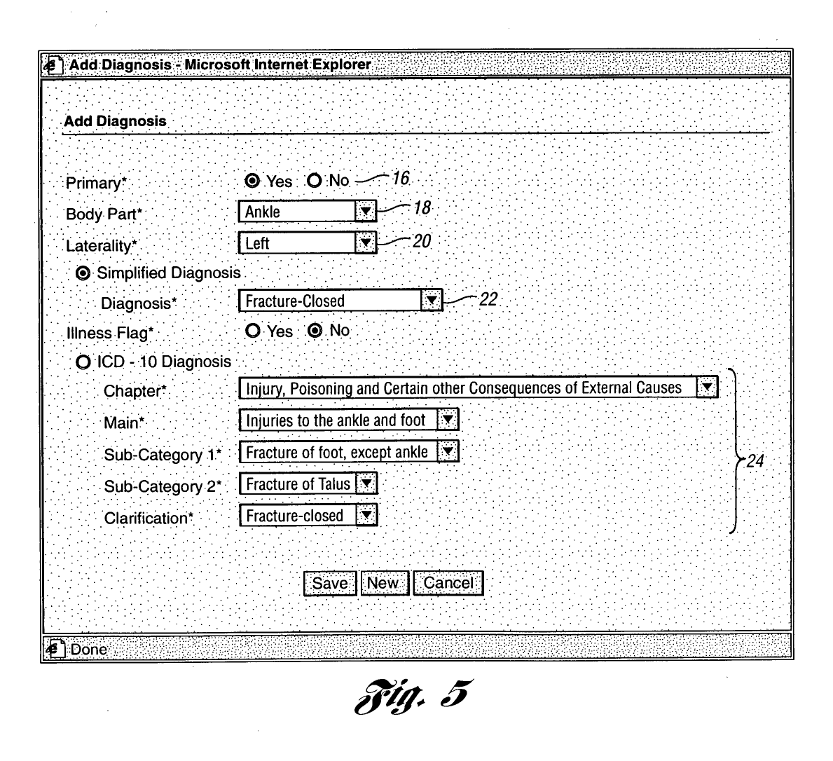

FIG. 5 is an example GUI for defining a diagnosis in accordance with one embodiment of the EMR aspect of the present invention. Selections 16 determine whether the diagnosis is a primary or otherwise. Preferably, up to four diagnoses may be entered. Drop-down menu 18 enables a user to select injured body part(s). Drop-down menu 20 enables a user to select the laterality for the injury.

A user may specify a “Simplified Diagnosis” from drop-down menu 22, or define a diagnosis from among the International Statistical Classification of Diseases and Related Health Problems (ICD) from among drop down menus 24. ICD classifications can be obtained from the Center for Disease Control and Prevention, 1600 Clifton Rd., Atlanta, Ga. 30333.

Preferably, the selection 24 made at each level determines selections that are available in the next level of the hierarchy. The preferred pathway is: Chapter, Main, Sub-Category 1, Sub-Category 2 (if applicable) and Clarification (if applicable). While laterality and body part are not applicable for every diagnosis, documentation when appropriate is important in maintaining an accurate medical record.

Occupational diagnoses may be documented using the “ICD” or “Simplified Diagnosis pathways.” When using the Simplified Diagnosis pathway, the corresponding ICD automatically displays based on a combination of body part, laterality, and Simplified Diagnosis selections.

Preferably, a “Plan” GUI is provided enabling a user to input interventions for resolving the patient's problem or injury. A “medication” form allows a user to delete or view prescription/non-prescription medications already ordered for a patient during the current visit, order new medications, and complete medication order forms for medications to be given outside of the medical department. Ordering new medications preferably includes defining the name of the medication, the dosage, specific dosage instructions, the number to dispense, the number of refills, and any alerts (e.g., allergy alerts). Preferably, medications and immunizations that are ordered during a patient visit are automatically entered into the person's medical history.

Functionality for printing prescriptions may also be provided. Preferably, user-access to the prescription printing functionality is restricted based on user ID or role. A “Dispense Medication/Immunization” GUI (not shown) enables authorized users to document details regarding dispensed medications/immunizations. Information to be submitted may include a “Route” if the medication is given intramuscular, subcutaneous or intradermal. Additional information for immunizations may include Series, Booster, Brand, Manufacturer, Lot Number, Expiration Date, Amount, Route, Site, Date and Time of Immunization, Next Due Date, etc.

A “Test Orders” GUI (not shown) enables a user to view, delete or add orders for patient tests. Test orders may include an audiogram, a breathalyser, an electrocardiogram, an electroencephalogram, electromyogram, blood work, urine test, pulmonary function tests, a radiology exam, a scan, a sleep apnea examination, a treadmill test, an ultrasound, a vision test, and user-defined tests (i.e., free-text description). The GUI may provide the user with data entry/selection fields for defining the date of the order, the date of the test, the test results, the entity to perform the test, and/or test conclusions.

A “Treatment Orders” GUI (not shown) enables a user to view, delete or add orders for patient treatment. Treatment orders may include medical goods such as an ace wrap, arm sling, band aid, brace, cane, clavicle strap, crutches, etc., or wound care such as antibiotic ointment, butterflies, dry and wet dressing, dressing pressure, drainage, etc.

A “Response to Treatment/Observation” GUI (not shown) enables a user to input a patient's response to treatments and any significant clinical observations. Preferably, this is performed in a free-text fashion.

A “Referral” GUI (not shown) enables a user to add, view or delete current referral orders. Defining a referral includes specifying the referral type (e.g., specialist, etc.), the scope of the requested referral (e.g., evaluation, treatment, both), a referral name, address, telephone number, etc., an appointment date and time, and special instructions or comments.

A “Medical Restrictions” GUI (not shown) enables a user to view all open restrictions or expired restrictions with a revisit date (even if the restrictions is not within the current visit series), print a report listing all open restrictions, add a new restriction for the current visit, attach a restriction if this is a revisit in the same series of visits, unattach a restriction from the current visit if attached in error, edit a restriction from a “Restrictions for Current Visit” table, and delete a restriction from the “Restrictions for Current Visit” table. Adding a new restriction may involve defining the type of the restriction (e.g., temporary, permanent, etc.), a category for the restriction, a begin date, an end or thru date, and a revisit date.

A “Medical Leave” GUI (not shown) enables a user to view open and pre-scheduled medical leaves, view and edit closed and deleted medical leaves, attach an existing leave not previously attached to a visit, attach an open leave to a revisit in a series of visits, and begin a new “Unfit for Work” leave. In accordance with a preferred embodiment of the present invention, medical leaves are divided into four main categories: open, pre-scheduled, closed, and open/closed. Open medical leaves a reoccurring open medical leaves. Pre-scheduled leaves are used when a person knows in advance that they will be going on leave (e.g., for a scheduled surgery). Preferably, leaves can only be closed by an authorized health care representative. “Open/closed” leaves are for “Unfit for Work” medical leaves—when a person goes out on a medical leave but the leave is not entered into the OHSIM system.

Opening a new medical leave may include defining the type of leave (e.g., personal, occupational), the reason for the leave (e.g., unfit to work, etc.), the begin date, the end date, the update date, the requester, the manner requested, comments, the last day worked, contact information for the patient during the leave, and a diagnosis.

A “Visit Outcome” GUI (not shown) enables a user to summarize the medical visit, including whether the person is fit to work, needs medical restrictions, etc. This interface allows a user to record a disposition for the visit. To do so, the user may select or otherwise define an overall disposition, an indication as to whether a revisit is necessary, and if so, when. Additional user-definable/selectable information may include an indication as to whether the worker's compensation department should review the visit, a worker's compensation code, or an indication as to whether the visit poses a privacy concern for the patient.

Preferably, a “Complete Verification” screen is provided to the user indicating whether the extent to which any required fields in the GUIs (described above) have been completed.

In accordance with a preferred embodiment of the present invention, OSHA logic is applied to the visit information upon a successful verification that all required data has been entered. This feature of the present invention will be discussed in greater detail below.

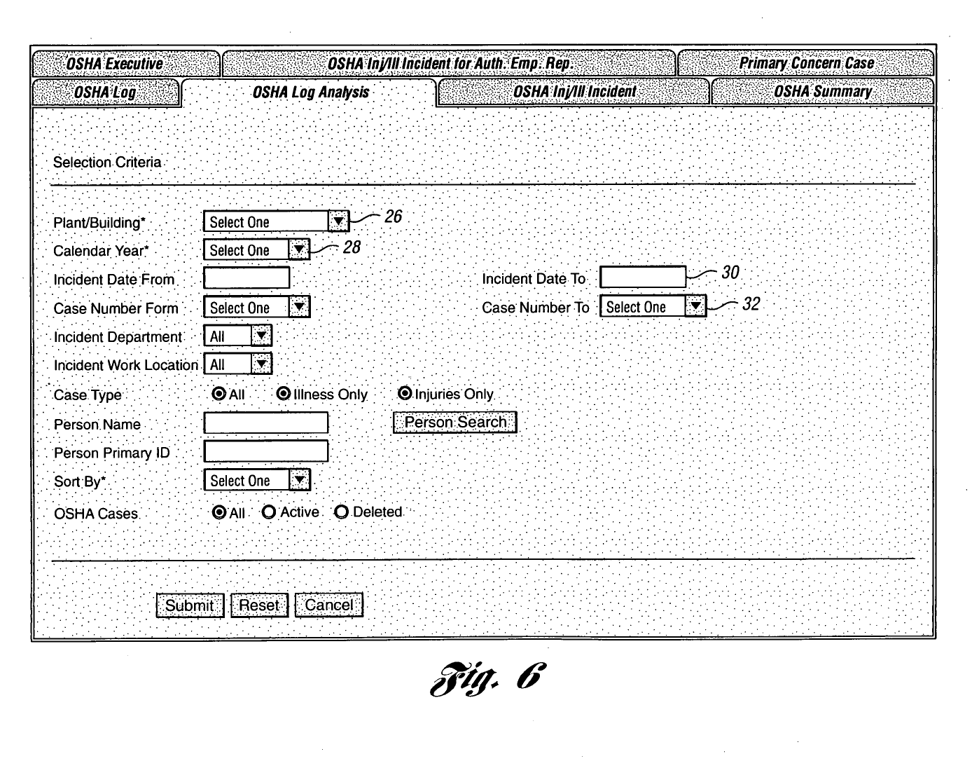

FIG. 6 is an example GUI for implementing an OSHA log analysis in accordance with the present invention. Notably, an OSHA log report may be generated on multiple levels of granularity (e.g., by date, plant, department, work location, person, etc.) Selection criteria for the analysis may include a plant/building 26, a calendar year 28, an incident date range 30, a case number range 32, an incident department, an incident location, a case type, and personal identification information for a person-specific search.

OSHA Logic

Tables 3 through 9 contain example business rules and processing logic for processing visit data and generating reports, including formal OSHA log reports. For example, business rules and logic such as that exhibited in Tables 3 through 9 may be executed by the OHSIM application to process and automatically identify visits that are OSHA-recordable (e.g., visits to be included in an official OSHA log). This automated aspect of the present invention reduces or eliminates error and inconsistency typically associated with the conventional “human-implemented” decision making process to determine which visits are OSHA-recordable.

Notably, the business rules and processing logic contained in Tables 3 through 9 are only examples to assist in the understanding and implementations of the present invention. Tables 3 through 9 are not intended to limit the scope or application of the present invention.

TABLE 3
Example OSHA Case Number Definition

OSHA Case numbers may be generated based on the following criteria:
Date of Incident
Incident Plant/Building and OSHA Log ID selection combination
Case Number Format/Layout: #####-YY-NNNNN
##### = OSHA Log ID
This number may represent the Plant/Building code or
a variation thereof
YY = 2-digit year (based on Date of Incident)
NNNNN = automatically system generated sequential number

TABLE 4
Example Triggers to Call OSHA Logic

| (1) | Whenever an Occupational Original Visit (also known |
|---|---|
| | as TOV-First Time Occupational Visit) is completed |
| | or the first time. |
| (2) | Whenever an Occupational Original Visit (also known |
| | as TOV-First Time Occupational Visit) is deleted. |
| (3) | Whenever an Occupational Revisit is completed for |
| | the first time. |
| (4) | Whenever an Occupational Revisit is deleted. |
| For any of the following triggers, the visit involved | |
| is assumed to have been completed for the first time. | |
| (1) | Whenever the Complete Verification Tab is selected |
| | on any Occupational Visit. |
| (2) | Whenever the Visit Type changes. |
| A visit/visit series changes from “Occupational” to “Personal”. | |
| A visit/visit series changes from “Personal” to “Occupational”. | |
| (3) | Whenever Visit Association changes. Visit |
| | Association changes are done via the View/Update |
| | Visit Information Task on the Navigation Frame. For |
| | example, an (occupational) Original Visit changes to |
| | an (occupational) Revisit (i.e. V1 becomes V2c). |
| | An (occupational) Revisit changes to an |
| | occupational) Original Visit (i.e. V3b becomes |
| | V4), or an (occupational) Revisit is linked to a |
| | different (occupational) Original Visit (i.e. V3b |
| | becomes V4c). |
| (4) | Whenever changes are made to the Occupational Detail |
| | screen. This includes adding, changing/updating, or |
| | deleting information from the screen. |
| (5) | Whenever changes are made to the Primary Diagnosis |
| | of any Occupational Visit. This includes adding, |
| | changing/updating, or deleting the Primary |
| | Diagnosis. This includes changing the Illness Flag |
| | on the Primary Diagnosis from “Yes” to “No” OR “No” |
| | to “Yes”. |
| (6) | Whenever changes are made to Prescription or Non- |
| | Prescription/Prescription Strength MEDICATION that |
| | are associated to an Occupational Visit. This |
| | includes adding or deleting. NOTE: If a |
| | Prescription or Non-Prescription/Prescription |
| | Strength MEDICATION is added via an occupational |
| | visit, but is DELETED outside of the occupational |
| | visit series, the OSHA Logic may not be called until |
| | the Complete Verification Tab is selected in any |
| | (occupational) visit within the series to which the |
| | Medication was associated. |
| (7) | Whenever changes are made to the Fracture field on |
| | the Radiology screen under the Test Orders Tab. |
| (8) | Whenever changes are made to the Treatment Orders |
| | screen. |
| (9) | Whenever the Referral Type field changes to or from |
| | “PHYSICAL THERAPY” on the Referral screen. |
| (10) | Whenever changes are made to the Medical Restriction |
| | screen. This includes Adding, Extending, Updating, |
| | and Deleting medical restrictions. |
| (11) | Whenever changes are made to the Medical Leave |
| | screen. This includes the Adding, Extending, |
| | Updating, Closing, and Deleting medical leaves. In |
| | other words, as long as there is an Originating |
| | Visit attached to the Medical Leave, whenever the |
| | leave screen is updated, in or outside of a visit, |
| | OSHA logic will be triggered. |
| (12) | Whenever changes are made to the Visit Outcome field |
| | on the Visit Outcome screen. |
| (13) | Whenever changes are made to the OSHA Case |
| | Adjustments screen. |

TABLE 5
Example OSHA Logic Processing

DETERMINATION OF THE OSHA LOG:
The OSHA Log to which the Incident belongs is based
upon the INCIDENT PLANT/BUILDING selected and the
OSHA Log ID associated to the plant/building
selected.
The INCIDENT PLANT/BUILDING selected may have more
than one OSHA Log associated to it.
An Incident may be assigned to ONE OSHA Log
WHICH OSHA RULES ARE FOLLOWED:
There are TWO Sets of OSHA Rules that may be
followed, based on the Date of Incident.
OSHA 200 rules apply if the Date of Incident is
PRIOR to Jan. 1, 2002
OSHA 300 rules apply if the Date of Incident is ON
or AFTER Jan. 1, 2002
WHEN IS OSHA LOGIC PROCESSED:
OHSIM will process OSHA Logic (based on the triggers
noted above) EXCEPT under the following conditions:
The Date of Incident occurred in a year 6 years
PRIOR to the current calendar year.
The Original Visit is created ON or AFTER
Jan. 1, 2002, but the Date of Incident is PRIOR to
Jan. 1, 2002.
A Revisit is created ON or AFTER Jan. 1, 2002, but
the Date of Incident is PRIOR to Jan. 1, 2002.
OSHA Logic will be processed for any OSHA CASE
ADJUSTMENTS made regardless of when the Adjustment was
created and/or the Date of Incident.

TABLE 6
Example Factors Making Visit OSHA Recordable

OCCUPATIONAL DETAIL FORM
Person loses consciousness
Person dies
ASSESSMENT FORM
The PRIMARY Diagnosis is used in determining OSHA recordability
Certain (Primary) Diagnosis Codes by themselves can make an incident OSHA Recordable.
A code system may be created to help identify such Diagnosis codes.
The illness Flag of the Primary Diagnosis together with the actual Diagnosis may
play a part in determining which OSHA rules to follow. See table below.

Example recordable code values are as follows:

OSHA Rules

| | | 200 | 200 | 300 | 300 |
|---|---|---|---|---|---|
| Code | Code Description | INJ | ILL | INJ | ILL |
| 1 | RRRR-2INIL-3INIL | R | R | R | R |
| 2 | RRRNR-2INIL-3INIL | R | R | R | NR |
| 3 | RRNRR-2INIL-3INIL | R | R | NR | R |
| 4 | RRNRNR-2INIL-3INIL | R | R | NR | NR |
| 5 | NRRRR-2INIL-3INIL | NR | R | R | R |
| 6 | NRRRNR-2INIL-3INIL | NR | R | R | NR |
| 7 | NRRNRNR-2INIL-3INIL | NR | R | NR | NR |
| 8 | NRRNRR-2INIL-3INIL | NR | R | NR | R |

R = Automatically Recordable
NR = Not Automatically Recordable
PLAN/TREATMENT FORM - TREATMENT ORDERS
Certain Treatment Codes can make an incident OSHA Recordable. In order for a treatment
code to make an incident OSHA recordable, the flag for the following items for the
selected treatment code must be equal to “Y”.

| (1) | BOHS740_LU_TREATMENT.OHS740_200_ALWAYS_REC_F | |
|---|---|---|
| | If this flag is set to yes it means that the Treatment code is automatically recordable: | |
| | a. | as long as the Date of Incident is prior to Jan. 1, 2002 |
| | b. | regardless if the treatment occurs in a New Visit or Revisit |
| (2) | BOHS740_LU_TREATMENT.OHS740_200_ALWAYS_REVIS_F | |
| | If this flag is set to yes it means that the Treatment code is automatically recordable: | |
| | a. | as long as the Date of Incident is prior to Jan. 1, 2002 |
| | b. | only when the treatment occurs in a Revisit |
| (3) | BOHS740_LU_TREATMENT.OHS740_300_ALWAYS_REC_F | |
| | If this flag is set to yes it means that the Treatment code is automatically recordable: | |
| | a. | as long as the Date of Incident is on or after Jan. 1, 2002 |
| | b. | regardless if the treatment occurs in a New Visit or Revisit |
| | If the Treatment = Durable Medical Goods, there are certain durable medical goods | |
| | that can make an incident OSHA recordable. In order for durable medical goods that | |
| | can make an incident OSHA recordable, the following terms must be equal to “Y”. | |
| (4) | BOHS746_LU_DUR_MED.OHS746_200_ALWAYS_REC_F | |
| | If this flag is set to yes it means that the Durable Medical Goods code is | |
| | automatically recordable: | |
| | a. | as long as the Date of Incident is prior to Jan. 1, 2002 |
| | b. | regardless if the durable medical good occurs in a New Visit or Revisit |
| (5) | BOHS746_LU_DUR_MED.OHS746_300_ALWAYS_REC_F | |
| | If this flat is set to yes it means that the Durable Medical Goods code is | |
| | automatically recordable: | |
| | a. | as long as the Date of Incident is on or after Jan. 1, 2002 |
| | b. | regardless if the treatment occurs in a New Visit or Revisit |
| | If the Treatment = Wound Care, there are certain wound cares that may make an | |
| | incident OSHA recordable. In order for wound cares to make an incident OSHA | |
| | recordable, the following terms must be equal to “Y”. | |
| (6) | BOHS748_LU_WND_CA.OHS748_200_ALWAYS_REC_F | |
| | If this flat is set to yes it means that the Wound Care code is automatically recordable: | |
| | a. | as long as the Date of Incident is |
| | | prior to 1/1/200 |
| | b. | regardless if the wound care occurs |
| | | in a New Visit or Revisit |
| (7) | BOHS748_LU_WND_CA.OHS748_300_ALWAYS_REC_F | |
| | If this flag is set to yes it means that the Wound Care code is automatically recordable: | |
| | a. | as long as the Date of Incident is on |
| | | or after Jan. 1, 2002 |
| | b. | regardless if the wound care occurs |
| | | in a New Visit or Revisit |

PLAN/TREATMENT FORM - Medications
Certain medications can make an incident OSHA Recordable. If the medication selected is either
PRESCRIPTION or NON-PRESCRIPTION/PRESCRIPTION STRENGTH, then the
incident may be OSHA recordable.
PLAN/TREATMENT FORM - Test Orders
If the Test Order of “Radiology” is selected AND the Fracture? field is designated as “Y”,
1 then the incident is OSHA recordable.
PLAN/TREATMENT FORM - Referrals
If the referral type selected is PHYSICAL THERAPY then the incident is OSHA recordable.
PLAN/TREATMENT - Medical Leave
A Medical Leave (with an originating visit):
IS NOT automatically recordable if it is created PRIOR to the data transfer from TWOS/OHS to OHSIM
IS automatically recordable (regardless of the Visit Outcome) if it is created AFTER the data
transfer from TWOS/OHS to OHSIM, and the incident has a Date of Incident prior to Jan. 1, 2002
IS automatically recordable (regardless of the Visit Outcome) if it is created after the data
transfer from TWOS/OHS to OHSIM, and the incident has a Date of Incident on or after Jan. 1, 2002,
unless the medical leave is only for one day and that day equals the Date of Incident.
PLAN/TREATMENT - Medical Restrictions
A Medical Restriction:
IS NOT automatically recordable if it is created before the data transfer from TWOS/OHS to OHSIM
IS automatically recordable (regardless of the Visit Outcome) if it is created after the data
transfer from TWOS/OHS to OHSIM, and the incident has a Date of Incident prior to Jan. 1, 2002
IS automatically recordable (regardless of the Visit Outcome) if it is created after the data
transfer from TWOS/OHS to OHSIM, and the incident has a Date of Incident on or after Jan. 1, 2002,
unless the medical restriction is only for one day and that day equals the Date of Incident.
VISIT OUTCOME FORM
Certain Visit Outcomes will make an incident OSHA Recordable. For a visit created before the data
transfer from TWOS/OHS to OHSIM, do the following:

| | |
|---|---|
| (1) | Always record a case if the Visit Outcome = fit for work with restrictions |
| (2) | Always record a case if the Visit Outcome = unfit for work |

For a visit created after the data transfer from TWOS/OHS to OHSIM, and with a Date of Incident
before Jan. 1, 2002:

| | |
|---|---|
| (1) | Only a Visit Outcome = unfit for work is automatically recordable (regardless of the |
| | Date of Incident). |

For a visit created after the data transfer from TWOS/OHS to OHSIM, and with a Date of Incident
on/after Jan. 1, 2002, do the following:

| | |
|---|---|
| (1) | A Visit Outcome = unfit for work is automatically recordable unless the Visit Date |
| | equals the Date of Incident. |

TABLE 7
Example Contents of OSHA Log

Primary Diagnosis Rules:
For any OSHA Cases created PRIOR to conversion, the following
applies with regards to the PRIMARY DIAGNOSIS:

| (1) | The Primary Diagnosis information appears under | |
|---|---|---|
| | a Description of Injury/Illness column for the | |
| | 200 Log. | |
| (2) | The Primary Diagnosis displayed on the OSHA Log | |
| | is that of the visit that created the OSHA Case | |
| | unless the case is modified. | |
| | a) | If an OSHA Case (created prior to |
| | | conversion) is modified after conversion |
| | | but PRIOR to Jan. 1, 2002, then the Primary |
| | | Diagnosis displayed is that of the most |
| | | recent visit with the INCIDENT year within |
| | | the series of visits for the OSHA Case. |
| | b) | If an OSHA Case (created prior to |
| | | conversion) is modified after conversion |
| | | but ON or AFTER Jan. 1, 2002, then the |
| | | Primary Diagnosis displayed is that of |
| | | the visit that created the OSHA Case. |

For any OSHA Cases created AFTER conversion, the following
applies with regards to the PRIMARY DIAGNOSIS:

| | |
|---|---|
| (1) | The Primary Diagnosis information appears under |
| | a Description of Injury/Illness column for the |
| | 200 Log and under a Describe injury or illness, |
| | parts of body affected, and object/substance |
| | that directly injured or made person ill column |
| | for the 300 Log. |
| (2) | The Primary Diagnosis displayed on the OSHA Log |
| | is that of the most recent visit within the |
| | series of visits for the OSHA Case. |

PRIVACY CONCERN RULES:
These Rules ONLY apply to those cases with a Date of
Incident ON or AFTER Jan. 1, 2002.
An Incident is considered to be of Private Concern
when one (or any combination) of the following
occurs:

| | |
|---|---|
| (a) | The primary diagnosis selected has been flagged |
| | as sensitive |
| (b) | The body part associated to the primary diagnosis |
| | has been flagged as sensitive |
| (c) | The yes radio button is selected for the privacy |
| | concern field on the visit outcome screen |

Wherever Primary Diagnosis and/or Body Part is
mentioned (throughout this section), it is referring
to the primary diagnosis of the MOST RECENT visit
within the visit series.
When the Privacy Concern Rules are applied, depending
on the circumstance, the OSHA Log may display
information in the following manner:

| | | PRIVACY |
|---|---|---|
| PRIMARY | | CONCERN |
| DIAGNOSIS | BODY PART | FIELD (V.O.) |
| (a) Circumstance: | | |
| Sensitive | Non-Sensitive | No |
| Sensitive | Non-Sensitive | Yes |
| Non-Sensitive | Non-Sensitive | Yes |
| Display: | | |
| A column will display “Privacy Concern Case” | | |
| A column will display “Privacy Concern Case”/Actual | | |
| Body Part Description/Laterality | | |
| A column will NOT display Object or Substance | | |
| (b) Circumstance: | | |
| Sensitive | Sensitive | No |
| Sensitive | Sensitive | Yes |
| Non-Sensitive | Sensitive | No |
| Non-Sensitive | Sensitive | Yes |
| Display: | | |
| A column will display “Privacy Concern Case” | | |
| A column will display “Privacy Concern Cast”/Sensitive | | |
| Body Part Description/Laterality | | |
| A column will NOT display Object or Substance | | |
| (c) Circumstance: | | |
| Non-Sensitive | Non-Sensitive | No |

| Display: | |
|---|---|
| A column will display “Person's Name” | |
| A column will display Actual Diagnosis | |
| Description/Actual Body Part Description/Laterality and | |
| Object or Substance information | |
| ILLNESS CASES RULES: | |
| For Illness Cases with PERMANENT restrictions. | |
| On the OSHA 200 Log (Date of Incident is PRIOR to | |
| Jan. 1, 2002), enter an asterisk in an appropriate | |
| illness column. | |
| On the OSHA 300 Log (Date of Incident is AFTER | |
| Dec. 31, 2001), DO NOT enter an asterisk. | |
| OSHA LOG CHECKMARKS: | |
| OSHA Logic may check illness data tables for OSHA | |
| Recordable cases in order to determine where | |
| particular checkmarks would be placed on the OSHA | |
| Log | |
| OSHA Log Injury/Illness Specific Values - PLACEMENT Flag | |
| OSHA 200 | |
| Description: | |
| O | No Placement |
| A | Occupational skin diseases |
| | or disorders |
| B | Dust Diseases of the lungs |
| C | Respiratory conditions due |
| | toxic agents |
| D | Poisoning |
| E | Disorders due to |
| | physical agents |
| F | Disorders associated with |
| | repeated trauma |
| G | All other occupational illnesses |
| OSHA 300 | |
| Description: | |
| O | No Placement |
| 1 | Injury |
| 2 | Skin disorder |
| 3 | Respiratory condition |
| 4 | Poisoning |
| 5 | All Other Illness |

TABLE 8
OSHA Counting (200 Logic)

GENERAL ASSUMPTIONS:
This counting logic applies to occupational
visits with a Date of Incident PRIOR to Jan. 1, 2002.
All examples imply a Date of Incident < Jan. 1, 2002.
Counting refers to restricted days and/or days away.
Count Monday through Friday only using the
corporate calendar and exclusive of known
corporate holidays.
Wherever there is an overlap in the date ranges
between Days Away and Restricted Days, Days Away
will override.
The counting logic provided within this section
applies to ALL OSHA cases unless otherwise
specified.
COUNTING OF RESTRICTED DAYS:
Permanent Restrictions
DO NOT count restricted days for a permanent restriction
Visit Outcome
COUNT a restricted day for Visit Outcomes = UNFIT FOR
WORK, UNLESS the Date of Incident equals the Visit Date,
then do NOT count a restricted day.
OSHA Case Adjustment
Count all adjustments related to the
increase or decrease of restricted days
regardless of when the Adjustment was
created and regardless of the Date of Incident.
Counting of Days Away:
Count Days Away inclusive of the Begin Date
through the End Date, unless otherwise specified.
NEVER count a day away where the Date of Incident
equals the Begin Date of a leave.
Count Days Away for a medical leave based on
justification.
NEVER count Days Away for a medical leave
where the days are NOT Justified.
Count Days Away inclusive of the Begin Date
through the End Date, unless otherwise
specified.
NEVER count a day away where the Date of
Incident equals the Begin Date of a leave.
Count Days Away for a medical leave based on
justification.
NEVER count Days Away for a medical
leave where the days are NOT Justified.
OSHA Case Adjustment
Count all adjustments related to the increase or
decrease of days away regardless of when the Adjustment
was created and regardless of the Date of Incident.
NOTE: The OHSIM system will NOT allow an
adjustment to include the Date of Incident.
Requirement to Update OSHA Records:
Update OSHA case records for 5 years following
the end of the calendar year (for the date of
injury/onset of illness) to which the records
relate:
Review visits for 5 years following the end of
the year (for the date of injury/onset of
illness) to which the record relates.
If recordable, enter an individual case entry
(e.g., J. Smith's sprain with injury date of
Mar. 10, 1998) on the Log for the year of injury/onset
of illness date (e.g., John's case on the 1998 Log).
If changes occur related to the case with regard to
recordability or counting, update the individual
case entry for a maximum of 5 years following the
end of the calendar year (for the injury/onset of
illness date) to which the record relates. Reflect
any adjustments related to the individual case entry
on that Log.
Update the Log year-to-date totals (the totals
for each column on the last page of that Log) if
changes are made to the individual case entry.
Prepare the Annual Summary totals for printing.

TABLE 9
OSHA Counting (300 Logic)

GENERAL ASSUMPTIONS:
This counting logic ONLY applies to occupational
visits with a Date of Incident ON or AFTER
Jan. 1, 2002.
All examples imply a Date of Incident Jan. 1, 2002.
Counting refers to restricted days and/or days
away.
Count ALL calendar days, regardless of whether or
not the employee was normally scheduled to work.
(This includes all weekends and holidays.)
Wherever there is an overlap in the date ranges
between Days Away and Restricted Days, Days Away
will override.
CAP the total Count of Restricted Days and/or
Days Away at 180 calendar days. (i.e. Days
Away = 100, and Restricted Days = 100, Total Days
Counted still equals 180). All restricted days
and days away are associated with occupational
cases.
The counting logic provided within this section
applies to ALL OSHA cases unless otherwise
specified.
COUNTING OF RESTRICTED DAYS:
Restrictions
Count restricted days inclusive of the Begin Date
through the End Date, unless otherwise specified.
DO NOT count a restricted day where the Date of Incident
equals the Begin Date of a restriction.
Permanent Restrictions
If an OSHA Case has a Permanent Restriction associated
to it, make sure that at least ONE restricted day is
entered.
Visit Outcome Field
A Visit Outcome-UNFIT FOR WORK will be counted as a
restricted day, UNLESS the Date of Incident EQUALS the
Visit Date.
OSHA Case Adjustment
Count all adjustments related to the increase or decrease
of restricted days regardless of when the Adjustment was
created and regardless of the Date of Incident.
COUNTING OF DAYS AWAY:
Medical Leaves (with an originating visit)
Count Days Away inclusive of the Begin Date through the
End Date, unless otherwise specified.
DO NOT count a day away where the Date of Incident
equals the Begin Date of a leave.
Count Days Away for a medical leave based on
justification.
NEVER count Days Away for a medical leave where
the days are NOT Justified.
OSHA CASE ADJUSTMENT:
Count all adjustments related to the increase or
decrease of days away regardless of when the
Adjustment was created and regardless of the
Date of Incident.
NOTE: The OHSIM system will NOT allow an
adjustment to include the Date of Incident.
REQUIREMENT TO UPDATE OSHA RECORDS:
Update OSHA case records for 5 years following
the end of the calendar year (for the date of
injury/onset of illness) to which the records
relate:
Review visits for 5 years following the end of the year
(for the date of injury/onset of illness) to which the
record relates.
If recordable, enter an individual case entry
(e.g., J. Smith's sprain with injury date of
Mar. 10, 1998) on the Log for the year of injury/onset
of illness date (e.g., John's case on the 1998 Log).
If changes occur related to the case with regard to
recordability or counting, update the individual case
entry for a maximum of 5 years following the end of the
calendar year (for the injury/onset of illness date) to
which the record relates. Reflect any adjustments
related to the individual case entry on that Log.
Update the Log year-to-date totals (the totals
for each column on the last page of that Log) if
changes are made to the individual case entry.
Prepare the Annual Summary totals (vertically
total columns G through L and M1 through M7).

OHSIM Reports

The OHSIM system is configured to present processed health and safety data in a plurality of different reports and report formats.

“Incident Reports” compile and display information collected during a patient visit or re-visit. A user is provided with selectable criteria to customize a report (e.g., for incidents at a plant, for a particular individual, etc.). As discussed in greater detail with regard to the IIM, plant level clinicians and others may view incident investigations reports resulting from a reported incident.

An OSHA Log may be the official Occupational Safety and Health Administration (OSHA) Log. An OSHA Log Analysis provides selection criteria to customize what is displayed on the Log. An OSHA Injury/Illness Incident report provides information from a medical visit (in particular occupational detail information) for particular OSHA Case(s). The report provides supplementary information regarding Case(s) on the log. An OSHA Summary may be used to meet employee-posting requirements in accordance with OSHA requirements. An OSHA Execution report provides information regarding Occupational Medical Visit activity. An OSHA Inj/Ill Incident for Authorized Employee Representatives provides information from a medical visit (in particular, occupational detail information) for particular OSHA Case(s). This report provides Case supplementary information regarding a Case(s) on the OSHA Log and is available to Authorized Employee Representatives as defined by OSHA. A Privacy Concern Case report provides confidential information related to privacy concern cases as defined by OSHA.

A “Medical Leaves by Facility” report displays leaves in selected statuses for selected or user role-defined plant/building(s). Selection criteria allows a user to customize the data display by a particular department or work location as well as by leave type (personal or occupational) and active, unattached, NWA, and deleted. A user can also search by leave status (closed, open, open-closed and pre-scheduled). In addition, the report can be sorted by leave end date, employee name, work location, etc.

A “Medical Restrictions by Facility” report enables a user to view all individuals with restrictions in selected statuses for selected plant/building(s). Selection criteria allow a user to customize data display by selecting a visit type (personal or occupational) and status (active, deleted, expired, and expired with a revisit date). In addition, the report can be sorted by restriction end date, employee name, or work location.

A “Medical Visits by Facility” report is a visit log for a particular treatment facility. Selection criteria allows a user to customize the report by selecting a visit type (FTOV, Occupational, Personal, or Short) as well as a date range. In addition, a user can customize the data display by selecting a Sort By option (Person Name, Visit Type, Visit Outcome, Last Updated By, or Work Location). A user can search within any date range. Preferably, if the date range is thirty-one days or less, the report is available online. If the date range is greater than thirty-one days, the report is a batch report and will not be available for immediate viewing.

A “Medical Revisit” report allows a user to print a report of all scheduled medical revisits. A user can search by date multi-day increments (e.g., up to 31-day increments). Preferably, the printed report separates required revisits, restriction revisits, medical leave revisits, and immunization revisits onto separate sheets.

A “Medical Restrictions by Individual” report allows a user to view the medical restriction history for a person. Selection criteria allows a user to customize the data display by selecting a visit type (personal or occupational) and status (active, deleted, expired, and expired with a revisit date). In addition, the report can be sorted by restriction end date, employee name, or work location.

A “Medical Leave by Individual” report allows a user to view the medical leave history for an individual. the data display by selecting a leave type (personal or occupational) and active, unattached, NWA, and deleted. A user can also search by leave status (closed, open, open-closed and Pres-scheduled). In addition, the report can be sorted by leave type, leave begin date, and OSHA case number.

A “Visit Summary by Individual” report allows a user to print a report of all visits to the Medical Department for a particular person. A user can elect to print only OSHA, occupational or personal visits with associated revisits or visits for a date range. An original or OSHA visit with associated revisits selection typically result in an immediate online report. A Multiple Visits by Date Range selection is preferably implemented in a batch report.

In addition to the “standard” reports described above, the OHSIM system is capable of and configured to implement custom analytical reporting. This aspect of the present invention is described in greater detail in accordance with the detailed description of the DAM module.

Table 10 contains a descriptive summary of task menu links that may be implemented in accordance with the EMR module GUIs and reports described in greater detail above. Notably, this descriptive summary depicts a preferred implementation of the EMR module, and is not intended to limit the scope of the present invention. An unlimited number of related tasks and corresponding role combinations may be implemented within the scope of the present invention.

TABLE 10

| Task Link | Description |
|---|---|
| HOME | Returns you to the OHSIM Welcome |
| | Page |
| CODE A VISIT | Access to visits for coding. You |
| | have access to all information |
| | within a visit as well as |
| | associated revisits to allow a |
| | coding decision. |
| MEDICAL TASKS | Expands to show a list of tasks |
| | related to a person. |
| Change Person | Change the name of the person on |
| | whom you want to enter information |
| | if you have been in another |
| | person's visit or history. |
| Create Visit | Create a new visit or revisit. |
| View/Update | Add information to or view a |
| History Information | person's medical history without |
| | opening a visit. |
| View History | View a person's medical history. |
| Information | |
| View/Update | Update a person's demographic |
| View/Update Visit | Reopen an existing visit for |
| Information | editing; View the visit summary for |
| | a selected visit; Change the visit |
| | association for existing visits. |
| View Visit | View visit information. |
| Information | |
| Batch Report | Used to view the status of a batch |
| Status | report request. |
| Incident | Customize a report for incidents at |
| Reports | a plant or for a particular |
| | individual. Plant level clinicians |
| | may view the report created by the |
| | investigator for an incident. |
| Management | Further customize the review of |
| Summary Report | incident reports. |
| Custom Analytical | Reports generated by Data Analysis |
| Reporting | Module. |
| Regulatory | Links you to various regulatory |
| Reports | reports. |
| OSHA Log | The standard Occupational Safety |
| | and Health Administration log. |
| | This report does not contain |
| | deleted cases. |
| OSHA Log | Customize a view of the log |
| Analysis | including deleted cases. |
| OSHA Inj/Ill | Customize by injury or illness. |
| Incident | |
| OSHA Summary | Used to meet employee posting |
| | requirements. |
| OSHA Extension | Displays activities for the past 30 |
| | days excluding the current date. |
| OSHA Inj/Ill | Reports a list of privacy concern |
| Incident for | cases. |
| Auth. Empt. | |
| Rep. | |
| Privacy Concern | Links you to various facility level |
| Case | reports. |
| Reports By | Lists all four types of revisits: |
| Facility | required revisits, restriction |
| | revisits, medical leave revisits, |
| | and immunization revisits. |
| Medical | Lists all visits to a treatment |
| Revisit Report | facility. |
| Medical Visits | Lists all visits to a treatment |
| by Facility | facility. |
| Medical | Lists all persons with restriction |
| Restrictions by | history in a facility. |
| Facility | |
| Medical Leaves | Lists all persons with leaves in a |
| by Facility | facility. |
| Reports For | Links you to various person level |
| Individual | reports. |
| Person | |
| Visit Summary Report | Print reports of medical visits |
| by Individual | with associated revisits. |
| Medical | Displays a person's |
| Restrictions Report | restriction history. |
| by Individual | |
| Medical Leave | Displays a person's leave |
| Report by | history. |
| Individual | |
| RESTRICTIONS/ | Access open restrictions for a |
| JOB PLACEMENT | person or all persons in a |
| | facility, department, or work |
| | location to allow you to |
| | either job place or open a NWA |
| | leave. |
| VIEW RESTRICTIONS | View a person's restriction |
| | history, displaying both open |
| | and closed/deleted |
| | restrictions. |
| VIEW/UPDATE | Access the leave history, |
| MEDICAL LEAVES | create a new leave and edit an |
| | existing leave depending on |
| | your role and some business |
| | rules. See the Medical Leave |
| | section for more details. |
| VIEW MEDICAL LEAVES | View a person's medical leave |
| | history, displaying both |
| | open/prescheduled and |
| | closed/deleted leaves. |
| VIEW/UPDATE USER | Access the EMR User |
| INFORMATION | Information screen displaying |
| | your current user information. |
| | Medical users requiring |
| | licensor update this |
| | information through this link. |
| WORK QUEUE MEDICAL | Displays the Work Queue Search |
| | screen, a quick means of |
| | accessing action items. |
| WORK QUEUE | Displays the Work Queue Search |
| | screen, a quick means of |
| | accessing action items. |
| FAQ | Access a list of frequently |
| | asked questions. |
| GIRS | Link to the Global Incident |
| | Reporting Application home page. |
| Help | Link to the OHSIM online help |
| | files. |
| Ergonomics | Link to the HCM Healthcare |
| | Ergonomics website. |
| Health Care | Link to the HCM online website. |
| Management | |

Incident Investigation Module (202)

The Incident Investigation Module (IIM) is an online tool that enables users to capture information from the investigation of a work-related injury/illness incident, a property damage incident, or a near miss. It enables users to generate detailed reports of specific incidents, specific corrective actions, and provides users with the capability to generate a summary report for all incidents occurring within a specific time frame. The information stored within IIM can be used for risk analysis and loss control.

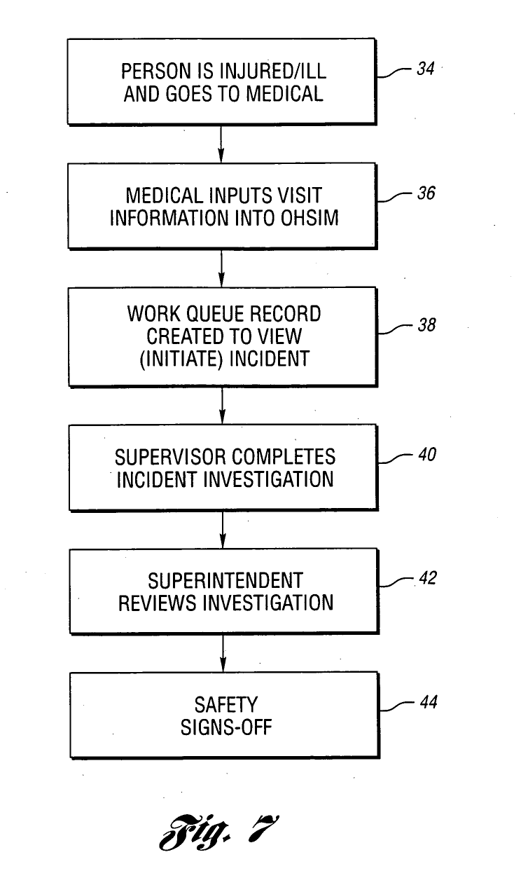

FIG. 7 is a block-flow diagram illustrating a preferred methodology for using and implementing the IIM. Notably, the content and arrangement of the diagram illustrated in FIG. 7 may be adapted to best-fit a particular implementation of the present invention. As represented in block 34, an incident investigation process begins when a person is injured or ill and visits his or her medical facility or department for treatment. As described in greater detail in accordance with the EMR aspect of the OHSIM system, a healthcare representative inputs information relating to the medical visit into the OHSIM system, as represented by block 36. As a result, a “Work Queue” record for the incident is automatically generated within the OHSIM system, as represented in block 38. Work Queue records are accessible and searchable through the IIM module. Next, as represented in block 40, an authorized/qualified individual (e.g., supervisor) completes an incident investigation, and reports his/her findings into the IIM. Preferably, after the incident has been investigated, it is reviewed by more senior management (block 42) and signed-off on by a corporate safety representative (block 44).

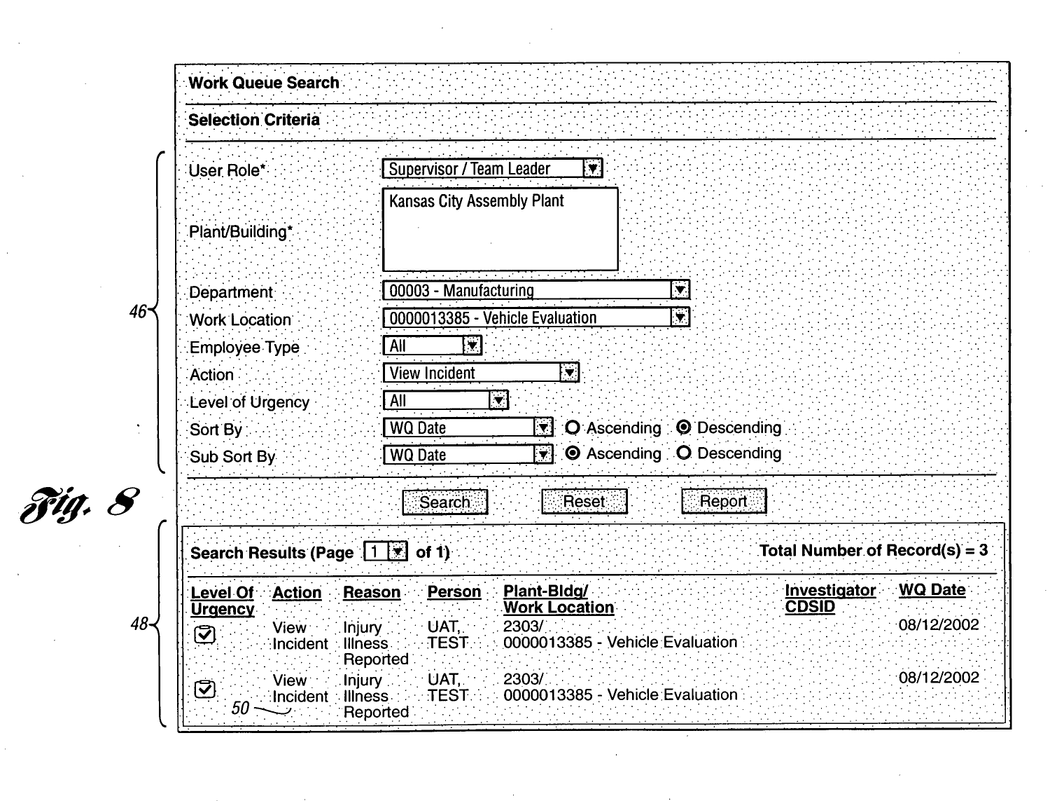

FIG. 8 is an example GUI illustrating a Work Queue Search. This GUI provides users with a flexible tool for accessing task information relating to an incident investigation. Preferably, the Selection Criteria 46 and Search Results 48 appear on the same window for ease of use and viewing. By providing “hotlinks” (e.g., 50) to more information about a particular record, users may easily and quickly access screens or pop-up messages to help complete various tasks. For example, selecting hotlink 50 will cause a medical incident report to display. In addition, the user is provided with buttons or selections (not shown) to initiate an investigation and/or send a notification to an investigator.

Following are some examples of how different user roles might use the Work Queue:
Supervisors can search for all new incidents requiring an investigation in their work location or within the plant/building. They can also indicate whether employees with restrictions can be placed in a job.
Safety engineers can search for all new outstanding investigations within their plant.
Superintendents can search for new injury/illness incidents requiring investigation and overdue action items.
Area managers can search for overdue action items.
Medical personnel can view a list of incomplete visits, revisits due, unattached leaves, and assigned tasks.
Human resources representatives can search for any unplaced employees and edit leaves.
Worker's compensation representatives can view a list of new first time occupational visits (FTOVs) or review visits requiring code adjustments.

Table 11 contains example task descriptions and roles corresponding to various “Actions” within selection criteria 46.

TABLE 11

| ACTION | | |
|---|---|---|
| DESCRIPTION | TASK DESCRIPTION | ACCESS BY ROLE |
| Complete | Click the action | Supervisor Safety |
| Investigation: | link to open the | Engineer* |
| Filters those | Investigator | *Will see all |
| investigations | Information screen, | investigations |
| that the user has | and complete all | |
| initiated. | the required | |
| | screens in the | |
| | investigation. | |
| Review | Click the action | Supervisor |
| Restriction(s): | link to review | |
| Filters reported | restrictions on the | |
| open restrictions | Job Placement | |
| from medical. | screen. Click | |
| | (Yes) if the person | |
| | can be placed. If | |
| | (No) is selected, | |
| | the record is | |
| | transferred to | |
| | Human Resources to | |
| | determine if a no | |
| | work available | |
| | leave is warranted. | |
| Sign Off | Click the action | Safety Engineer |
| Investigation: | link to open the | |
| Filters | View Investigation | |
| investigations | screen. Click | |
| that have been | [Sign Off] to | |
| reviewed and | approve the | |
| accepted by the | investigation. | |
| superintendent. | Click [Reject] to | |
| Also filters | send it back to the | |
| investigations | investigator to | |
| completed by | update. If the | |
| safety but not | investigation is | |
| signed off. | rejected, a reason | |
| | or comments must be | |
| | entered. | |
| Update | Click the action | Supervisor Safety |
| Investigation: | link to open the | Engineer |
| Filters reviewed | View Investigation | |
| investigations | screen. The | |
| that a | Superintendent | |
| superintendent | Comments or Reason | |
| and/or safety | for Rejection will | |
| determine need | display. Update | |
| modification or | the investigation | |
| clarification. | as needed. | |
| View Incident: | Click the action | Supervisor Safety |
| Filters reported | link to open the | Engineer |
| injury/illness | Medical Incident | Superintendent* |
| incidents from | Report, detailing | *Read-only access |
| medical that | the Person's | |
| require | Statement of | |
| investigation. | Incident along with | |
| | other medical | |
| | details. Click | |
| | [Initiate | |
| | Investigation] at | |
| | the bottom of the | |
| | report to start the | |
| | investigation. | |
| | *Superintendent | |
| | does not have | |
| | access to initiate | |
| | investigation. | |
| Notification: | Click the action | Superintendent |
| Filters overdue | link to view | Area Manager |
| reported | Medical Incident | |
| injury/illness | Report for | |
| cases from medical | injury/illness | |
| that have not been | cases and Incident | |
| completed or | Investigation | |
| reviewed. | Report for all | |
| Displays yellow | others. | |
| (2-4 days) or red | | |
| (over 4 days) | | |
| levels of urgency. | | |
| Review | Click the action | Superintendent |
| Investigation: | link to open the | |
| Filters completed | View Investigation | |
| investigations | screen. Click | |
| that require | [Accept] to approve | |
| approval. | and send the | |
| | investigation to | |
| | safety for sign | |
| | off. Click | |
| | [Reject] to send it | |
| | back to the | |
| | investigator to | |
| | update. | |
| Review | Click the action | Safety Engineer |
| Notification: | link to open the | |
| Filters completed | Incident | |
| investigations | Investigation | |
| awaiting review by | Report. | |
| superintendent. | | |
| Review Anon Near | Not available. | Safety Engineer |
| Miss: Reserved for | | |
| future | | |
| functionality. | | |

As mentioned above, the EMR and IIM modules are configured to generate a variety of automatic or semi-automatic e-mail notifications to assist in the effective reporting, investigation and resolution of injury/illness incidents within the workplace. Within the EMR module, health care representatives are able to identify the incident supervisor of an injured or ill employee while reporting a medical visit. The OHSIM system may be configured to automatically send an e-mail notification of the visit to the specified incident supervisor that includes a link to the incident pending investigation.

Similarly, e-mail notifications may be initiated within the IIM module via the work queue as well. For example, if another user finds an incident in the Work Queue that should be investigated by someone else, that user can send e-mail directly to the supervisor, reassigning responsibility for the investigation. Superintendents and area managers can send e-mail to the designated supervisor, while viewing the medical incident in the Work Queue. In each instance, the OHSIM system generates an e-mail notifications that include a link to the incident report.

In one implementation of the present invention, there are four types of investigations:
Human Injury/Illness—medical personnel process an injured or ill person. Injury/illness investigations can only be accessed from the Work Queue task link.
Near Miss—any incident, which could have resulted in a serious occupational injury, illness, or significant property damage.
Property Damage—all property damage incidents where the loss exceeds $5,000-$15,000 depending on the specific plant, including business interruptions.
Risk Assessment—an evaluation of a job task or work environment for all potential hazards including, but not limited to, those causing acute injury or cumulative trauma, and other adverse health effects caused by exposure to heat, cold, noise, radiation, and toxic materials.

Notably, a wide-variety of different investigation types may be supported by the OHSIM system depending upon the particular implementation of the present invention.

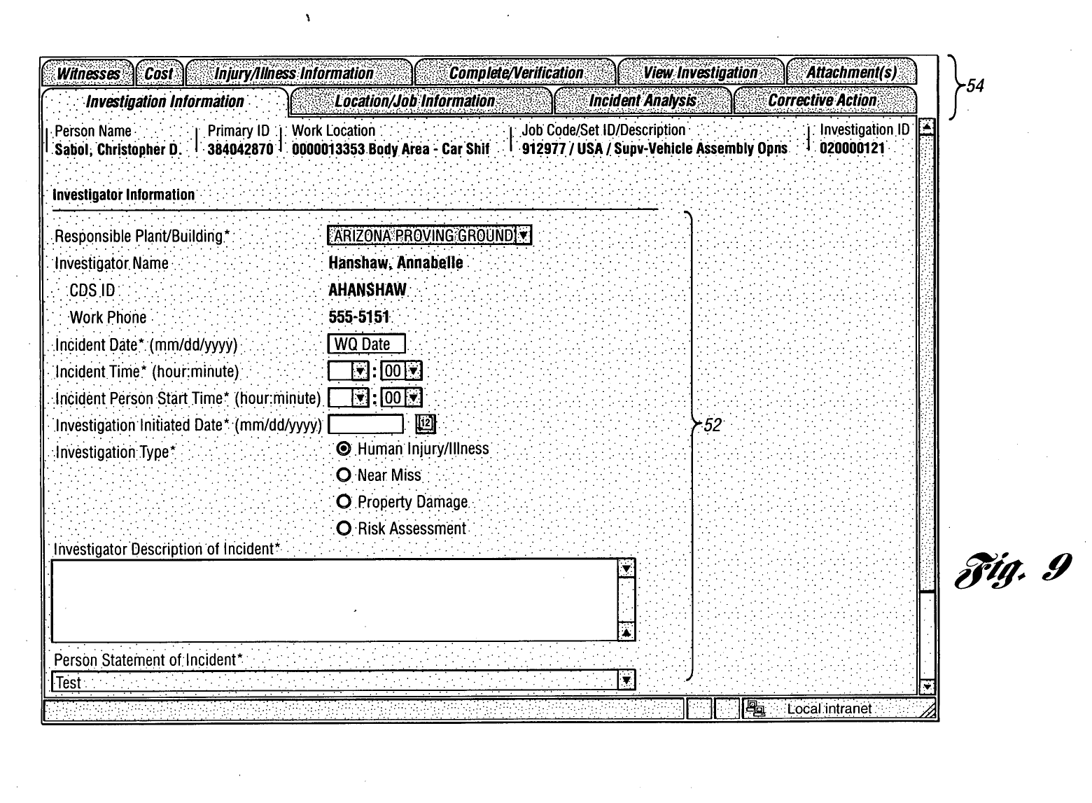

FIG. 9 is a multi-tab GUI for collecting a plurality of information relating to a new incident investigation. Notably, the content and arrangement of the GUI illustrated in FIG. 9 may be modified or adapted to best fit a particular implementation of the present invention.

The investigator information screen illustrated in FIG. 9 is used to capture information 52 such as a plant or building in which the incident occurred, the name and contact information for the incident investigator, the date and time of the incident, the investigation type, the investigator's description of the incident, and statements made by one or more witnesses to the incident. Additionally, the GUI includes header information for the incident including the person's name, identification number, work location, job description, and an investigation number for the incident.

Notably, the features shown and described with respect to FIG. 9 are all included in one or a plurality of screen tabs 54 including investigator information screen, location/job information screen, incident analysis screen, corrective action screen, witnesses screen, cost screen, injury/illness information screen, complete/verification screen, view investigation screen, and attachments screen.

Preferably, if medical personnel have already processed an injured or ill person, the human injury/illness investigation type is automatically selected. Some indicant details may be pre-populated with information entered by medical personnel. According to one embodiment, the investigator must initiate injury/illness investigations from the Work Queue.

The location/job information screen (not shown) is used to capture data related to where the incident occurred and specific data related to the incident. In one embodiment, this screen is divided into two sections, a location information section, and a job information section. If the incident happened in an off-facility location, a checkbox may be selected and specific location information may be entered. If an injury/illness incident did not happen at a person's normal work location, the displayed fields may change accordingly. The job information portion of the screen captures specific data related to the job of a person involved in an injury/illness incident.

Information collected at the location/job information screen may include an indication as to whether the incident occurred on or off facility premises, an indication as to whether the incident occurred at the person's normal place of work, information describing the location of the incident (e.g. plant/building, department, work location, incident location/bay, station number, etc.), and employee job information (e.g. job code, job description, job experience, shift, etc.).

The incidence analysis screen (not shown) may be implemented to document the incident in greater detail. In one embodiment, the incident analysis screen is divided into three sections. The first section defines the general source of injury. The second section assesses the actual and potential risk, using a risk factor matrix calculation. The third section defines the contributing factors to the incident, such as substandard acts and conditions.

The incident analysis screen may receive general incident analysis information including the type of contact or the manner in which the employee was exposed to the incident or injury, the source of the injury, and the task/activity the employee was performing when the incident/injury occurred.

A loss severity/probability of reoccurrence portion of the incident analysis screen may include selection of an actual loss severity/probability of reoccurrence value as well as a potential loss severity/probability of reoccurrence value. A contributing factors portion of the incident analysis screen may enable a user to define a substandard act, a substandard condition, a personal factor, a job factor, and/or controlling program element that led to or otherwise contributed to the incident under investigation.

Table 12 sets forth example loss severity/probability of reoccurrence values in accordance with one implementation of the present invention.

TABLE 12

| | Non- | | | Major Injury/ | |
|---|---|---|---|---|---|
| Severity of | Disabling | First | | Less Than | |
| Event | Injury/Illness - | Aid/Req. | Injury/Days | Full Recovery | Death/ |
| Likelihood | No medical treat- | Medical | Lost, Total | (permanent | Total |
| of Event | ment required | Treatment | Recovery | impairment) | Disability |
| 1 event/ | 1 | 2 | 3 | 4 | 5 |
| 40+ Years | | | | | |
| 1 event/ | 2 | 4 | 6 | 8 | 18 |
| 4 Years | | | | | |
| 1 event/ | 3 | 6 | 9 | 12 | 15 |
| 6 Months | | | | | |
| 1 event/ | 4 | 8 | 12 | 16 | 20 |
| 2 Weeks | | | | | |
| 1 event/ | 5 | 10 | 15 | 20 | 25 |
| Day | | | | | |

A corrective action screen (not shown) may be utilized to capture recommended corrective actions to prevent reoccurrence of an incident. Notably, multiple corrective actions may be added for a single incident. In addition, a corrective action may be deleted if it no longer applies.

In one implementation, the corrective action screen receives user input defining, for a new corrective action, the type of correction action (e.g. interim, permanent), a description of the recommended corrective action, a target completion date for the recommended corrective action, and an actual completion date. In addition, a person responsible for implementing or otherwise overseeing the corrective action may be identified.

The witnesses screen (not shown) may be utilized to capture information from and about any witness to the incident. Witness information includes the witness's name, identification, contact information, and comment. Witness records may be removed from the incident investigation, but preferably the witness record is retained.

A cost screen (not shown) may be used to capture known actual and potential costs of the damages to people, equipment, environment and material, etc. Current plant policies and procedures for costing may be utilized as guidelines to complete this screen. According to one embodiment, an actual and potential cost value is input for each cost category (i.e. people, equipment, environment, material, etc.). People cost represents the cost of people involved in the incident (i.e. the cost of replacing an injured person with someone else, etc.). Equipment cost represents the cost of the equipment involved in the incident (i.e. the cost of repairing or replacing equipment as a result of an incident occurring). Environment cost is the environmental cost associated with the incident (i.e. the cost to clean up a chemical spill).

An injury/illness information screen (not shown) may be utilized to capture information entered by medical personnel for an injured/ill person. Preferably, this screen is implemented as a read-only screen and cannot be changed by investigators. It is additionally preferred that any diagnosis information within a person's medical record is maintained as confidential and does not display on the screen. Preferably, any other appropriate information is automatically transferred or otherwise transmitted to the incidence investigation record from the person's medical record. In one embodiment, a button is provided allowing an investigator to view diagnosis information. Only OSHA-recordable events will be displayed. Information displayed may include the body part or area affected by the person's injury or illness, the side of the body or region where the injury/illness is located, and an injury/illness type (e.g. injury, illness, repetitive motion, etc.). Days away from work due to this incident may be identified as the number of full days unavailable for work due to an injury or illness. This field may be blank if the information has not already been entered into the EMR. Preferably, a first time occupational visit number is provided as a unique number assigned to new occupational visits and may also be blank if the information has not previously been entered into the EMR (discussed above).

A complete/verification screen may be provided that is similar to the EMR verification screen shown in FIG. 4. The complete/verification screen may be utilized to determine the status of the documentation for an incident investigation. In one implementation, a checkmark appears in the “required fields completed” column next to any screen for which all required fields have captured data. The user may return to an incomplete screen from the complete/verification screen by clicking on the corresponding screen name hyperlink. Notably, an investigation cannot be designated complete until all required fields are done. Once all required data fields have been completed, a user may select the complete button and be presented with a sign off form (not shown). In one embodiment, once an investigation has been signed-off on, no additional editing may take place.

An attachment screen (not shown) may be utilized to attach pertinent information to an investigation. The attachment can be any type of file such as a photograph, spreadsheet, graphic or document.

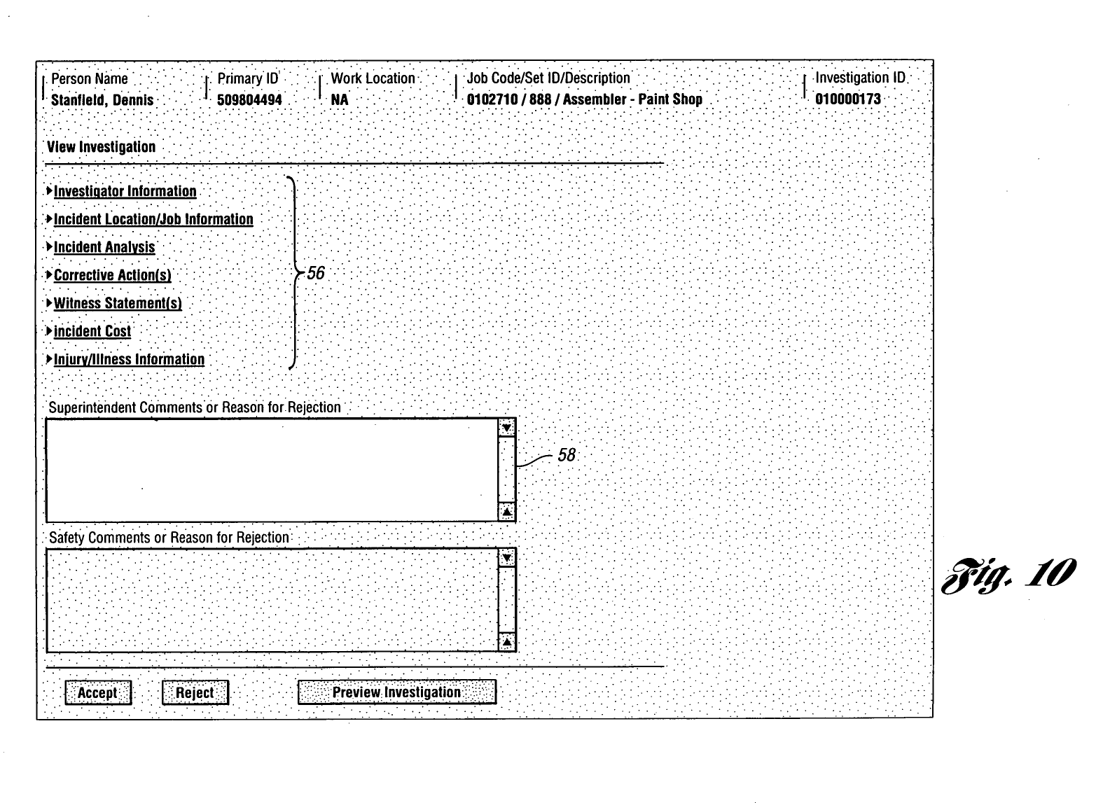

FIG. 10 illustrates an example view and investigation screen in accordance with one aspect of the present invention. The view investigation screen provides an easy way to review existing information about an incident investigation. A summary of the entire investigation may be displayed from the screen, and can be viewed before printing a paper copy. According to one embodiment, superintendents are transferred to the screen from the work queue in order to review and accept investigations completed by supervisors. Once the superintendent accepts an investigation, it is available in the work queue for the safety engineer to sign-off on. By selecting any of the hyperlinks 56 provided in the view investigation screen, the user is taken to a summary of information inputted into the corresponding screen (discussed above). Additionally, a superintendent may input comments 58 or a reason for rejecting the investigation and safety comments or reasons for the rejection.

Preferably, a restriction information screen (not shown) is provided as an aspect of the present invention to input selection criteria and view persons with active medical restrictions. This information assists supervisors in assigning employees to jobs that accommodate their restrictions. Preferably, the restriction information screen is also accessible from the work queue (discussed above). Search criteria may include plant/building, department, work location, person name, and person identification number. By selecting one of the search results, a user may be presented with a description of that user's restriction(s), in the corresponding begin date, through date, and revisit date.

Additional search functionality may be provided enabling users to search investigation records. Search criteria may include investigation identification number, an investigator's identification number, person name, investigation type, incident plant/building, incident department, incident work location, and incidents that occurred within a user-specified date range.

An additional search screen enables users to search for people involved in or otherwise associated with incident records. Search criteria for the people search may include first name, last name, identification number, date of birth, country, plant/building, etc.

The incident investigation module may be programmed and configured to generate a plurality of reports based on information collected in connection with incident investigations.

Table 13 associates a plurality of IIM-related reports with likely users of those reports. Some reports are described in greater detail below.

TABLE 13

| Report | Users |
|---|---|
| Work Queue Management Report | Area Managers, Plant Safety, |
| | Test Track Safety, |
| | Divisional Safety, Country |
| | Safety, Corporate Safety, |
| | Plant Union Rep, Country |
| | Union Rep, HRA-Safety |
| Management Summary Report | Supervisors, Superintendent, |
| | Area Manager, HRA-Safety, |
| | Plant Safety, Test Track |
| | Safety, Plant Union Rep, |
| | Divisional Safety, Country |
| | Safety, Country Union Rep, |
| | Corporate Safety |
| Work Queue Lister Report | Any user with the Work Queue |
| | Task (Supervisors, |
| | Superintendents, Area |
| | Managers, Plant Safety, Test |
| | Track Safety) |
| Restrictions/Job Placement | Supervisors, Plant Safety, |
| Report | Test Track Safety |
| Regulatory Reports | Plant Safety, Test Track |
| | Safety, HRA-Safety, Plant |
| | Union Rep |
| Reports by Facility | All Plant Level Users, |
| | except Plant Union Rep |
| Reports by Individual | All Plant Level Users, |
| (Future Enhancement) | except Plant Union Rep |
| Corrective Action Report | Supervisors, Superintendent, |
| | Area Manager, HRA-Safety, |
| | Plant Safety, Test Track |
| | Safety, Plant Union Rep, |
| | Divisional Safety, Country |
| | Safety, Country Union Rep, |
| | Corporate Epidemiologist, |
| | Corporate Safety |
| Investigation Report | Supervisors, Superintendent, |
| | Area Manager, HRA-Safety, |
| | Plant Safety, Test Track |
| | Safety, Plant Union Rep, |
| | Divisional Safety, Country |
| | Safety, Country Union Rep, |
| | Corporate Epidemiologist, |
| | Corporate Safety |

A corrective action report may be utilized to generate a report for information regarding a corrective action, particularly an outstanding corrective action. Primary safety engineers, superintendents, and area managers may use such a corrective action report. Preferably, a corrective action report search screen is provided (not shown) for searching corrective actions by a variety of criteria including incident plant/building, investigation I.D. number, incident department, incident work location, corrective action type, and target date range. Search results include a listing of corrective actions by investigation I.D. number and include a description of the corrective action. Preferably, a hyperlink is provided enabling the user to view each investigation record.

An incident investigation report (not shown) may be utilized to view and print reports after an incident investigation has been entered into the system. Preferably, a search screen is provided enabling the user to search among all incidents according to a plurality of search criteria. Search criteria may include incident plant/building, investigator identification number, investigation type, incident department, incident work location, person or witness name, incident date range, incident job code/description, diagnosis/observation, type of contact, source of the injury, and task/activity. Additionally, incident reports may be searched according to loss severity/probability of reoccurrence including an actual value, potential value, a substandard act, a substandard condition, and a controlling program element or detail. Similar to the corrective action report, search results for the incident reports are preferably provided with a corresponding hyperlink enabling a user to view the relevant investigation record.

A management summary report screen (not shown) may be utilized to generate a report for occupational incident activity reported to a medical facility for treatment that occurred at a user's assigned plant/building. Preferably, an investigation link will appear for any investigation that has been initiated for an incident. If an investigation has not been initiated, only the injury/illness incident will display on the report but without corresponding investigation information. Near miss, property damage and risk assessment incidents may also be associated to an investigation and may be viewed through this report.

According to another aspect of the present invention, a plurality of regulatory reports may be automatically generated, including an OSHA log report, an OSHA log analysis report, an OSHA summary, and an OSHA injury/illness incident report for an authorized employee representative report. The OSHA log report is the official year-to-date occupational safety and health administration log. This report may not include deleted cases. Preferably, two different layouts are provided: Form 200 for years 2001 and prior; Form 300 for years 2002 and beyond.

The OSHA log analysis report provides selection criteria to customized what is displayed on the OSHA log report, including deleted cases. Preferably, two different layouts are provided: Form 200 for years 2001 and prior; Form 300 for years 2002 and beyond.

The OSHA summary report is used to meet employee posting requirements in accordance with OSHA requirements for the year 2002 and beyond. Preferably, summary counts for years 2001 and earlier appear on the last page of the OSHA log report.

The OSHA injury/illness incident report for an authorized employee representative is available to authorized employee representatives, as defined by OSHA, for the year 2002 and beyond. This report provides information from a medical visit (in particular, occupational detail information) for a particular OSHA case. Preferably, this report provides only case supplementary information regarding a case on the OSHA log, and does not show any information regarding the employee and the physician/health care professional. The layout for this report may be defined by OSHA Form 301.

A work queue management report (not shown) provides a tool for viewing incident work queue related counts at various stages. Preferably, statuses are displayed according to a green yellow and red status format for selected incident plants/buildings for incidents involving restrictions, incidents not initiated, incidents not complete, incidents awaiting review, incidents awaiting sign-off, and incidents awaiting update. The work queue management report is a real-time report, displaying information accurate to the date and time the report is generated. Totals for the green, yellow, and red statuses may be displayed by plant/building.

Data Analysis Module (204)

The data analysis module (DAM) is a custom analytical reporting aspect of the present invention. This aspect of the present invention provides users with an ability to compile and process organizational information relating to occupational health and safety. Basic and detailed reports for incident investigations, property damage, and near-miss incidents can be generated based on user selected criteria and include single plant or multi-plant reporting. This aspect of the present invention may be implemented in a web-based environment and may improve efficiency, standardize health and safety functions, and report/track trends for injury/illness, property damage, and near-miss incident types.

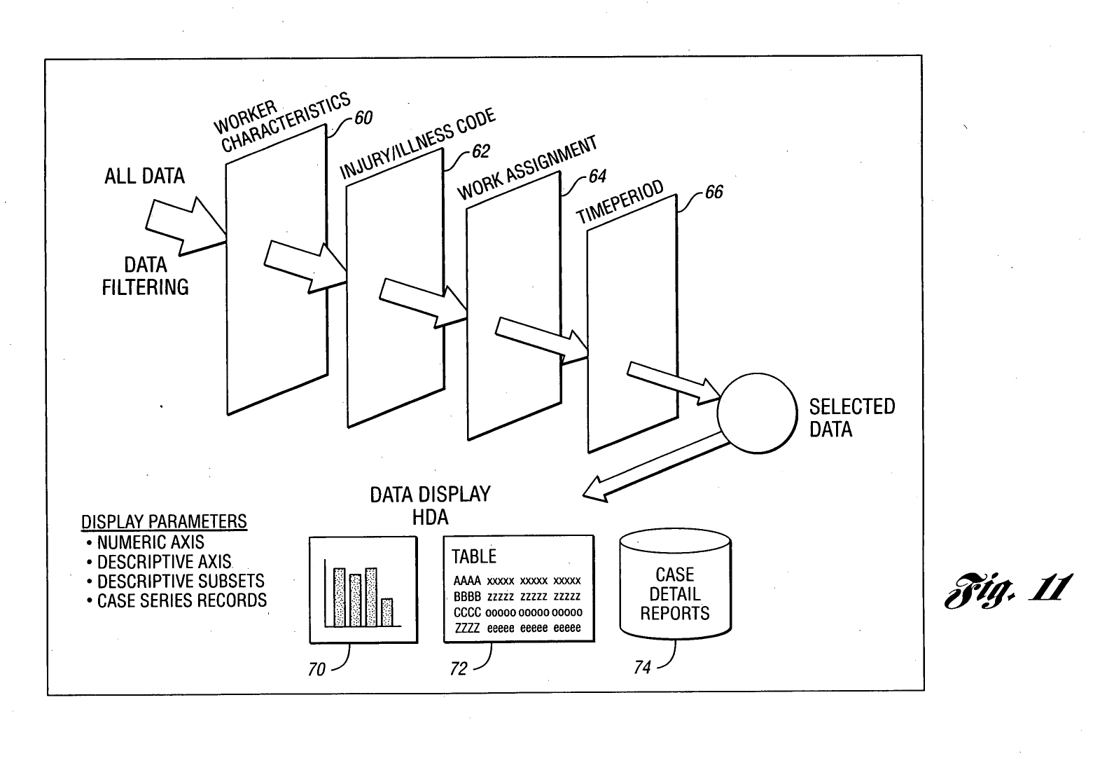

FIG. 11 graphically illustrates a methodology for utilizing the data analysis module aspect of the present invention. Data is filtered at a plurality of levels, including, but not limited to, worker characteristics 60, injury/illness codes 62, work assignment 64, time period 66, etc. to arrive at a final selected data set 68 for incorporation and/or presentation in a plurality of outputs (e.g. visual charts 70, data tables 72, database data exports 74, etc.).

Table 14 illustrates a comparison of some high-level functionality and distinguishing characteristics between the DAM module and the IIM/EMR modules.

TABLE 14

| IIM/EMR | DAM |
|---|---|
| Driven by single person | Driven by groups or |
| Data reviews are done | population of workers. |
| on a case by case | Ability to narrow down |
| basis. | or focus on clusters of |
| | workers. |
| | Presents trends and |
| | patterns by counts and |
| | rates. |
| | Feeds other Systems: |
| | PLAID, TIGR, POLR |

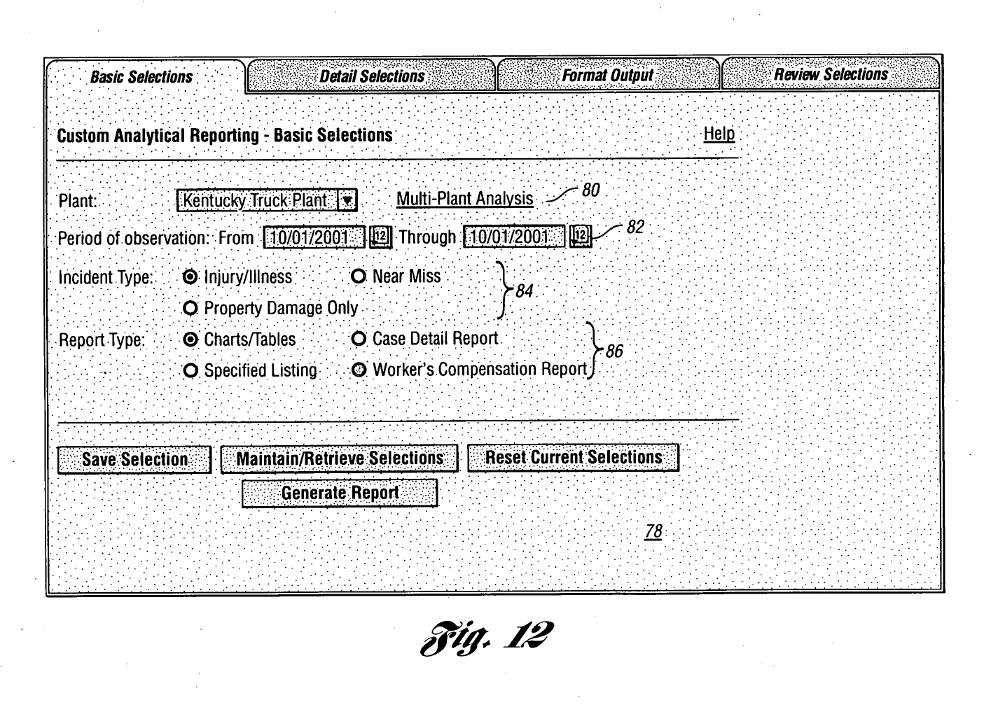

FIG. 12 is an example GUI having a plurality of tabs associated with data selection and output in the DAM. The basic selections form 78, as illustrated in FIG. 12, may include functionality for selecting a particular plant, or a multi-plant analysis 80, a period of observation 82, an incident type 84, and a report type 86.

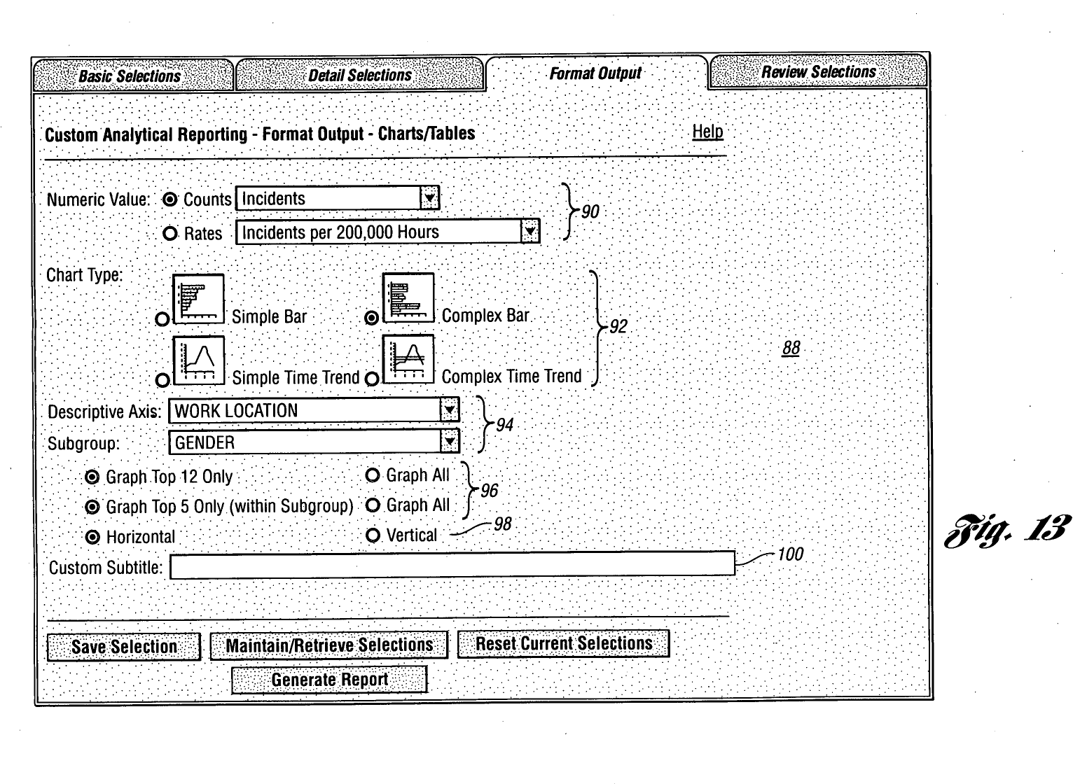

FIG. 13 is an example DAM form 88 for specifying the format of the data to be output. Selection criteria includes the numeric format of the output (e.g. discrete counts, rates over time, etc.) 90, chart type 92, a descriptive primary access and sub-group selection 94, a record scope selection 96, a chart orientation selection 98, and a custom subtitle 100. Description access information may include year, work location, visit type, type of contact, time on job, time into shift, task/activity, sub-standard condition, sub-standard act, source of injury type, source of injury detail, etc. Rate selections may include incident per 200,000 hours, persons per 1,000 workers, days away per 1,000 workers, days away per 200,000 workers, restricted days per 1,000 workers, restricted days per 200,000 hours, days away and restricted days per 1,000 workers, days away and restricted days per 200,000 hours, etc.

The format output form allows a user to modify the format of the chart/table or specified listing report. Notably, the information displayed on this screen may differ depending on the report type selected. The count values include the number of a specific item, such as incidence, days, persons, etc. The rate values include the rate at which an action occurred. The chart type selection 92 specifies the type of chart to be generated. Depending on the selection, different fields may be displayed or become unavailable. Table 15 contains example chart types corresponding to the type of data those charts might be utilized to display.

TABLE 15

| Chart Type | Examples Of When Used |
|---|---|
| Simple Bar | Number of incidents by department |
| Complex Bar | Number of incidents by department by |
| | shift |
| Simple Time | Number of incidents in a month by |
| Trend | department |
| Complex Time | Number of incidents in a month by |
| Trend | department by shift |

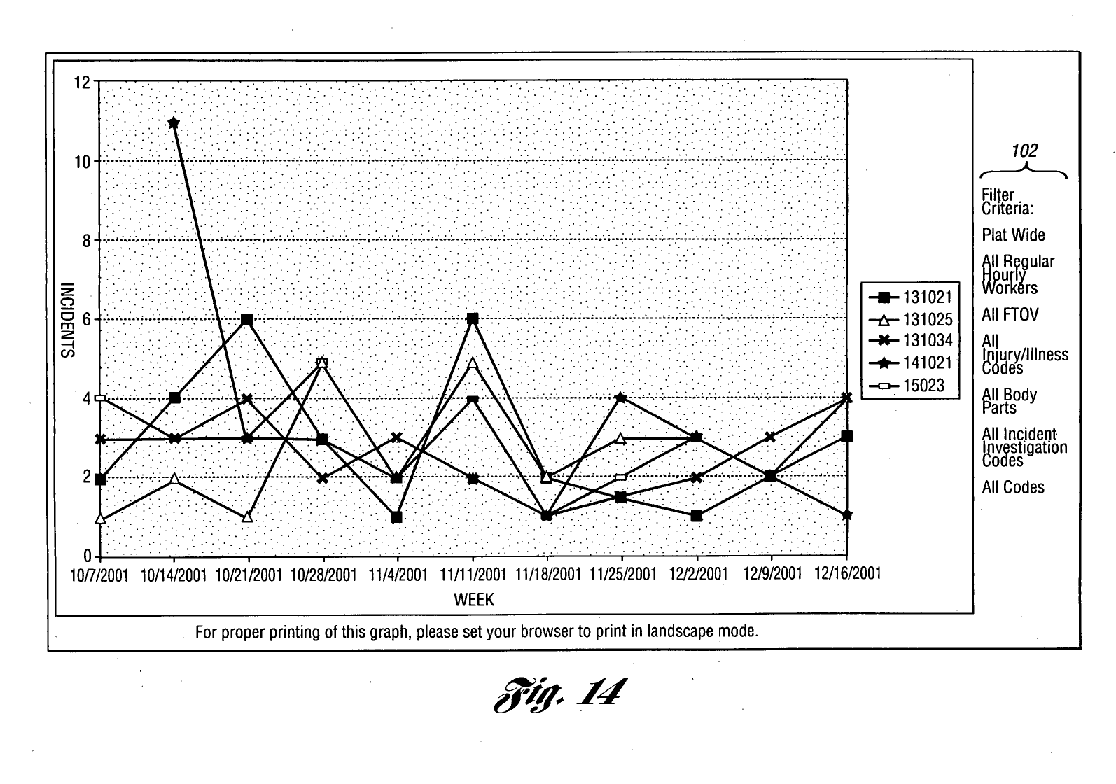

FIG. 14 is an example chart output in connection with the DAM aspect of the present invention. Notably, current filter criteria 102 is provided enabling a user to understand the status of the current filter selection.

A review selection tab (not shown) illustrates a summary of user-defined selections (e.g. basic selections, detailed selections, output format, etc.). Selections presented include the current status of organizational variables, personal variables, visit type, injury/illness variables, body parts, incident investigation codes, cost, output format, etc.

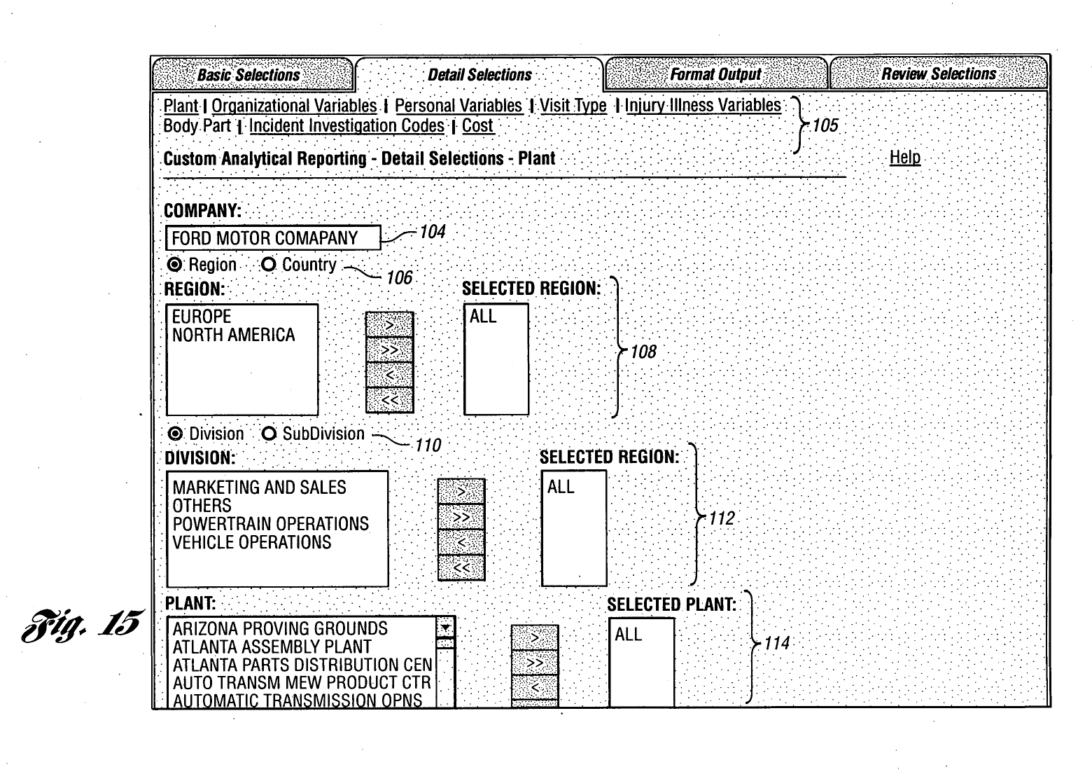

FIG. 15 is an example DAM GUI for specifying detail selections associated with statistical reporting in the DAM aspect of the present invention. More specifically, FIG. 15 illustrates plant selections associated with the custom analytical reporting. Notably, a variety of hyperlinks 105 may be selected by user to present the user with a form for specifying detail selections for a plurality of DAM-related analytical reporting parameters (e.g. plant selection, organizational variables, personal variables, visit type, injury/illness variables, body part, incident investigation codes, cost, etc.). Selections include company name 104, region/country selection 106, region/country selection functionality 108, division/subdivision selection 110, division, subdivision selection functionality 112, and plant selection functionality 114.

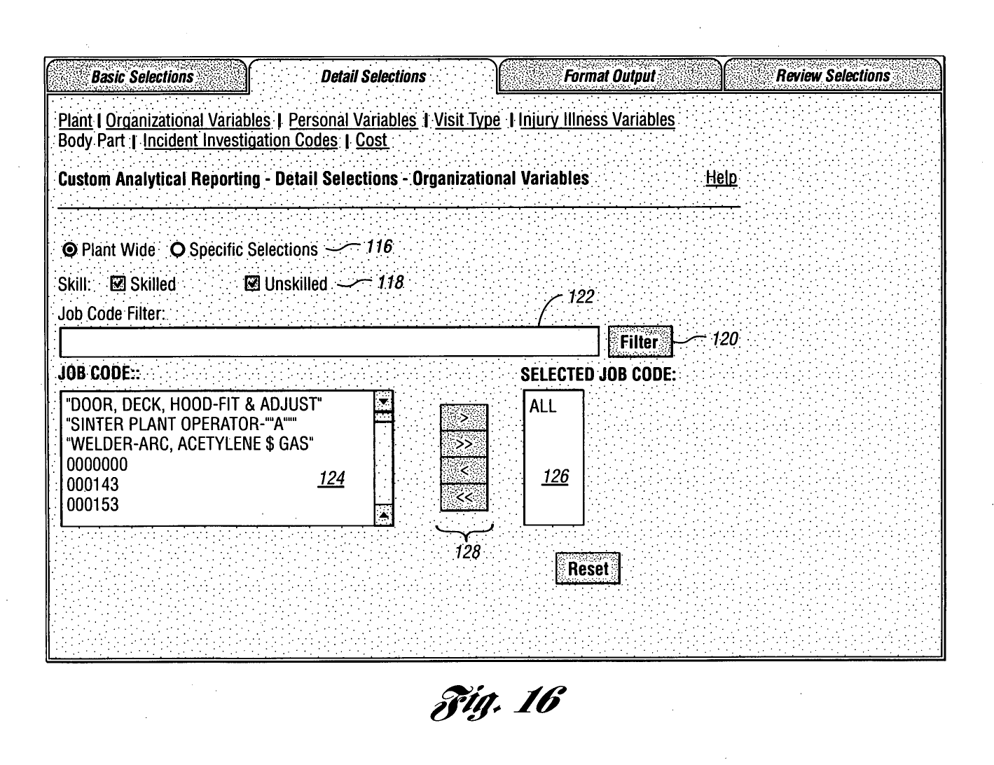

FIG. 16 is an example detail selection screen for organizational variables in accordance with the DAM aspect of the present invention. The organizational variable GUI shown in FIG. 16 enables a user to filter data by job code (e.g. plant-wide or specific job code selections) 116. Job skills may be generally categorized/filtered as skilled or unskilled 118. A job code filter 120 is provided enabling a user to search among textual descriptions of available job codes. For example, a user may search for all job codes associated with welding by inputting the term “weld” into the job code filter field 122, depress the “filter” button 120 and be presented with a plurality of job codes in field 124 for selection into a selected job code field 126 via selection functionality 128. Additional selections (not shown) may include in-plant groupings, departments, work locations, job processes, shifts, etc.

The personal variables GUI (not shown) enables a user to select information about the type of people to be reported on. The user can select to report on all or a specified selection of variables. Variable selections may include pay status (e.g. hourly, salary, etc.), employee types (e.g. regular, apprentice, agency, temporary, etc.), gender, seniority, time on job, age group, ethnic group, etc.

A detailed selection form for visit type (not shown) enables a user to select the medical case types to be reported on. The reports can be based on first time occupational visits, first time personal visits, or both. Selection fields include a first time occupational visit selection, a selection of government reportable cases (if FTOV is selected, a user can report on all FTOVs with one or more days away from work, and/or one or more restricted days at work, due to an occupational injury or an illness), cases with days away (report on all FTOVs with one or more days away from work due to an occupational injury or illness), cases with restricted days (report on all FTOVs with one or more restricted days at work due to an occupational injury or illness), and first time personal visits (for a non-occupational injury or illness).

A detailed selection form for injury/illness variables (not shown) provides the user with functionality to select the type of injury or illness to be reported on. One field that may be associated with the injury/illness variable screen includes a selection between all injury/illness codes or specific codes to be defined below. The following fields are filters for specifying specific injury/illness codes. A summary diagnosis/detail diagnosis selection is provided. Selecting a summary diagnosis enables a user to select from a drop down list of high-leveled diagnosis to report on. A detailed diagnosis, on the other hand, is selected to specify detailed diagnosis by ICD-10 codes, which are provided via drop down menu. An injury/illness code field allows a user to select one or more injury/illness codes to report on (i.e. blood exposure, burn, contusion, etc.). An injury/illness type field allows a user to select one or more injury/illness types to report on (i.e. illness, injury, repetitive motion, etc.). A chapter field allows a user to specify the detailed ICD-10 diagnosis chapter information (i.e. chapter 19 injury, poisoning and certain other consequences of external causes). A main category selection field enables a user to categorize/define the area associated with an injury/illness via ICD-10 code (i.e. 19-15327-injuries to the ankle and foot). Sub-category selection fields are also provided to describe or further define the injury (i.e. 19-15327-S91.0 open wound to ankle).

A body part detail selection form (not shown) enables a user to select body parts to be reported on. Users can select from all body parts or from specific body part selections. Body part selections may be made via body part group, body part, laterality, etc.

An incident investigation code detail selection GUI (not shown) enables a user to select from all or specific incident details to report on. One selection field includes the type of contact. For example, contact with a source of energy or substance. Another selection field includes the source of the injury. For example, if the type of contact was slip, trip, or fall, then the source of the injury value could be working surface. A task/activity field enables a user to specify what task or activity the person was doing when the incident occurred (i.e. maintenance or repair, emergency, material handling, etc.). A sub-standard act field allows a user to specify a result of a sub-standard condition that was allowed to exist in an individual resulting in a sub-standard act/behavior (i.e. failure to use personal protection equipment, removing safety devices, etc.). A sub-standard condition selection field specifies a condition that was allowed to exist in the work place that led up to the incident (i.e. congested or restricted action/area, inadequate ventilation, inadequate guards, etc.). A controlling program element field specifies the type of safety program that most directly applied to an incident under investigation (i.e. chemical safety, no program or standard, etc.). A loss severity/probability of reoccurrence field may reflect actual or potential values. A graph icon is provided to open a window allowing a user to select the actual loss of severity and the probability of reoccurrence. A vertical access presented within the window may represent the actual frequence or likelihood of the event occurring. A horizontal access may represent the actual severity of the event. (See Table 12 for an example loss severity/probability of reoccurring stable.) Preferably, color descriptions are provided for frequency. Green (low) may be tolerated but should be reduced if possible with minimal investment. Yellow (medium) should be modified unless unreasonable. Red (high) is not tolerated, and correction is mandatory. For injury/illness incidence, the color scheme can be interpreted based on severity logic as follows: green means no medical assistance was required, yellow means medical attention was required with complete recovery, red means the person was seriously injured and there is permanent impairment, or there was loss of life.

A cost screen GUI for making detail selections (not shown) may include a variety of price of cost related criteria to be reported on. For example, reports may include total actual and potential costs, actual cost only, and potential cost only. Cost ranges may be specified for the report in a variety of categories (e.g. total costs, people costs, equipment costs, environment costs, etc.). People costs include the cost of people involved in the incident (i.e. cost of replacing injured person with someone else, etc.). Equipment costs include the cost of the equipment involved in the incident (i.e. the cost of repairing or replacing equipment as the result of an incident occurring). Environmental costs include the costs associated with an incident (i.e. the cost to clean up a chemical spill, etc.).

Notably, the DAM aspect of the present invention is directly interfaced with the OHSIM suite (EMR, IIM, DAM). According to one embodiment of the present invention, some data fields are required, whereas other fields are dependent on the incident type. For instance, type of contact is required for injury/illness incident types, but it may not be a required field for near miss or property damage incidents. Table 16 summaries which fields which, according to one embodiment of the present invention, may be required in OHSIM for use in connection with DAM reporting on human injury/illness. Of course, fields may be required or not depending on the particular implementation.

TABLE 16

| | |
|---|---|
| Investigator Information | Responsible Plant/Building |
| | Incident Date |
| | Incident Time |
| | Incident Person Start Time |
| | Investigation Initiated Date |
| | Investigation Type |
| | Investigator Description of |
| | Incident |
| | Person Statement of Incident |
| Location/Job Information | Did the Incident occur at the |
| | Person's Normal Work Location? |
| | Incident Plant/Building |
| | Incident Job Code/Set ID/ |
| | Description |
| | Incident Process # |
| | Experience in Incident Job |
| | Incident Shift |
| Incident Analysis | Type of Contact |
| | Source of Injury/Detail |
| | Task/Activity |
| | Substandard Act |
| | Substandard Condition |
| | Controlling Program Element/ |
| | Detail |
| Corrective Action | Corrective Action Type |
| | Recommended Corrective Action |
| | Target Completion Date |
| | Responsible Person - CDS ID |
| | Responsible Person - Last Name |
| | Responsible Person - First Name |
| Witnesses - Screen not | Last Name |
| required | First Name |
| | Relationship |
| | Witness Comment |
| Cost - Screen not | People |
| required | Equipment |
| | Environment |
| | Material |
| Attachments - Screen not | Source File |
| required | Attachment Description |

Table 17 summarizes OHSIM fields which may be required for DAM near-miss reporting:

TABLE 17

| | |
|---|---|
| Investigator Information | Responsible Plant/Building |
| | Incident Date |
| | Incident Time |
| | Investigation Initiated Date |
| | Investigation Type |
| | Investigator Description of |
| | Incident |
| Location/Job Information | Incident Plant/Building |
| | Incident Shift |
| Incident Analysis | Task/Activity |
| | Substandard Act |
| | Substandard Condition |
| | Controlling Program Element/ |
| | Detail |
| Corrective Action | Corrective Action Type |
| | Recommended Corrective Action |
| | Target Completion Date |
| | Responsible Person - CDS ID |
| | Responsible Person - Last Name |
| | Responsible Person - First Name |
| Witnesses - Screen not | Last Name |
| required | First Name |
| | Relationship |
| | Witness Comment |
| Cost - Screen not | People |
| required | Equipment |
| | Environment |
| | Material |
| Attachment(s) - Screen | Source File |
| not required | Attachment Description |

Table 18, below, summarizes OHSIM fields which may be required for DAM property damage reporting:

TABLE 18

| | |
|---|---|
| Investigator Information | Responsible Plant/Building |
| | Incident Date |
| | Incident Time |
| | Investigation Initiated Date |
| | Investigation Type |
| | Investigator Description of |
| | Incident |
| Location/Job Information | Incident Plant/Building |
| Incident Analysis | Substandard Act |
| | Substandard Condition |
| | Controlling Program Element/ |
| | Detail |
| Corrective Action | Corrective Action Type |
| | Recommended Corrective Action |
| | Target Completion Date |
| | Responsible Person - CDS ID |
| | Responsible Person- Last Name |
| | Responsible Person- First Name |
| Cost - Screen not | People |
| required | Equipment |
| | Environment |
| | Material |
| Witnesses - Screen not | Last Name |
| required | First Name |
| | Relationship |
| | Witness Comment |
| Attachments - Screen not | Source File |
| required | Attachment Description |

While the best mode for carrying out the invention has been described in detail, those familiar with the art to which this invention relates will recognize various alternative designs and embodiments for practicing the invention as defined by the following claims.

1. A system for automated health and safety information management, the system comprising one or more computers operably programmed and configured to:
receive a plurality of data concerning patient medical visits resulting from occupational health or safety incidents;
process the data to automatically identify one or more patient medical visits that are OSHA-recordable; and
output a report including a summary of the data characterizing one or more patient medical visits that are OSHA-recordable.

2. The system of claim 1 wherein the data is processed based on pre-defined OSHA logic.

3. The system of claim 1 wherein the plurality of data characterizing the patient medical visit includes data representing the date of the incident, whether the patient died or lost consciousness, diagnosis, treatment, medications, test orders, referrals, medical leaves, medical restrictions, or an indication as to whether the patient is fit for work.

4. The system of claim 1 wherein the one or more computers are additionally programmed and configured to automatically display an indication as to whether enough data characterizing the patient medical visits has been provided to determine whether the visit is OSHA-recordable.

5. The system of claim 1 wherein the data processed includes data characterizing one or more prior medical visits for a particular patient.

6. The system of claim 1 wherein the occupational health or safety incidents include injuries and illnesses.

7. The system of claim 1 wherein the one or more computers are additionally programmed and configured to query the plurality of data concerning patient medical visits according to a plurality of user-defined criteria.

8. The system of claim 1 wherein the one or more computers are additionally programmed and configured to generate a report summarizing the occupational health or safety incidents for a particular organizational location or patient.

9. The system of claim 1 wherein the one or more computers are additionally programmed and configured to generate a report summarizing patient medical leaves of absence for a particular organizational location or patient.

10. The system of claim 1 wherein the one or more computers are additionally programmed and configured to generate a report summarizing patient medical restrictions for a particular organizational location or patient.

11. The system of claim 1 wherein the one or more computers are additionally programmed and configured to generate a report summarizing patient medical visits for a particular organizational location or patient.

12. The system of claim 1 wherein the one or more computers are additionally programmed and configured to electronically dispatch an investigator to investigate one or more of the occupational health or safety incidents.

13. The system of claim 1 wherein the one or more computers are additionally programmed and configured to receive a plurality of data concerning an investigation of one or more of the occupational health or safety incidents.

14. The system of claim 13 wherein the one or more computers are additionally programmed and configured to query the plurality of data concerning an investigation of one or more of the occupational health or safety incidents.

15. The system of claim 13 wherein the one or more computers are additionally programmed and configured to generate a report summarizing one or more incident investigations.

16. The system of claim 13 wherein the plurality of data concerning the investigation includes one or more corrective actions to avoid reoccurrence of the one or more of occupational health or safety incidents.

17. The system of claim 16 wherein the one or more computers are additionally programmed and configured to generate a report summarizing corrective actions.

18. The system of claim 1 wherein the one or more computers are additionally programmed and configured to:
filter received data at one or more filter levels based on one or more user-defined criteria; and
generate a report based on the filtered data.

19. The system of claim 18 wherein the filter levels include worker characteristics, injury/illness codes, work assignment or time period.

20. The system of claim 18 wherein the report includes a bar chart or a time trend.

21. A computer-implemented method for automated health and safety information management, the method comprising:
receiving into one or more computers a plurality of data concerning patient medical visits resulting from occupational health or safety incidents;
processing the data to automatically identify one or more patient medical visits that are OSHA-recordable; and
generating a report including a summary of the data characterizing one or more patient medical visits that are OSHA-recordable.

22. The method of claim 21 wherein the data is processed based on pre-defined OSHA logic.

23. The method of claim 21 wherein the plurality of data characterizing the patient medical visit includes data representing the date of the incident, whether the patient died or lost consciousness, diagnosis, treatment, medications, test orders, referrals, medical leaves, medical restrictions, or an indication as to whether the patient is fit for work.

24. The method of claim 21 additionally comprising automatically displaying an indication as to whether enough data characterizing the patient medical visits has been provided to determine whether the visit is OSHA-recordable.

25. The method of claim 21 wherein the data processed includes data characterizing one or more prior medical visits for a particular patient.

26. The method of claim 21 wherein the occupational health or safety incidents include injuries and illnesses.

27. The method of claim 21 additionally comprising querying the plurality of data concerning patient medical visits according to a plurality of user-defined criteria.

28. The method of claim 21 additionally comprising generating a report summarizing the occupational health or safety incidents for a particular organizational location or patient.

29. The method of claim 21 additionally comprising generating a report summarizing patient medical leaves of absence for a particular organizational location or patient.

30. The method of claim 21 additionally comprising generating a report summarizing patient medical restrictions for a particular organizational location or patient.

31. The method of claim 21 additionally comprising generating a report summarizing patient medical visits for a particular organizational location or patient.

32. The method of claim 21 additionally comprising electronically dispatching an investigator to investigate one or more of the occupational health or safety incidents.

33. The method of claim 21 additionally comprising receiving a plurality of data concerning an investigation of one or more of the occupational health or safety incidents.

34. The method of claim 33 additionally comprising querying the plurality of data concerning an investigation of one or more of the occupational health or safety incidents.

35. The method of claim 33 additionally comprising generating a report summarizing one or more incident investigations.

36. The method of claim 33 wherein the plurality of data concerning the investigation includes one or more corrective actions to avoid reoccurrence of the one or more of occupational health or safety incidents.

37. The method of claim 36 additionally comprising generating a report summarizing corrective actions.

38. The method of claim 21 additionally comprising:
filtering received data at one or more filter levels based on one or more user-defined criteria; and
generating a report based on the filtered data.

39. The method of claim 38 wherein the filter levels include worker characteristics, injury/illness codes, work assignment or time period.

40. The method of claim 38 wherein the report includes a bar chart or a time trend.

41. Computer software embodied in a computer-readable medium for automated health and safety information management, the computer software comprising:
an electronic medical record module configured to:
(i) receive a plurality of data concerning patient medical visits resulting from occupational health or safety incidents;
(ii) process the data based on pre-defined OSHA logic to automatically identify one or more patient medical visits that are OSHA-recordable; and
(iii) output a report including a summary of the data characterizing one or more patient medical visits that are OSHA-recordable.
an incident investigation module configured to:
(i) electronically dispatch an investigator to investigate one or more of the occupational health or safety incidents; and
(ii) receive a plurality of data concerning an investigation of one or more of the occupational health or safety incidents including one or more corrective actions to avoid reoccurrence of the one or more of occupational health or safety incidents; and
a data analysis module configured to:
(i) filter received data at one or more filter levels based on one or more user-defined criteria; and
(ii) generate a plurality of reports based on the filtered data.
